(19) United States
(12) Patent Application Publication
(10) Pub. No.: US 2014/0132649 A1
(43) Pub. Date: May 15, 2014

(54) SUBFRAME CONTROLLING CIRCUITS AND METHODS FOR FIELD SEQUENTIAL TYPE DIGITAL DISPLAY APPARATUS

(71) Applicant: PIXTRONIX, INC., San Diego, CA (US)

(72) Inventor: Jianru SHI, Haverhill, MA (US)

(73) Assignee: Pixtronix, Inc., San Diego, CA (US)

(21) Appl. No.: 13/675,756

(22) Filed: Nov. 13, 2012

(51) Int. Cl. G09G 5/10

(52) U.S. Cl. CPC G09G 5/10
USPC 345/694

(57) ABSTRACT

This disclosure provides systems, methods and apparatus, including computer programs encoded on computer storage media, for improving image quality of images displayed by a display apparatus. In one aspect, an apparatus for display images includes a plurality of pixels having at least two display elements configured to be controlled by a common data signal. The apparatus also includes a control matrix having, or each pixel, a single data interconnect that is configured to provide a data voltage. The control matrix also includes, for a set of pixels, an area modulation control logic for selecting a number of display elements included in each pixel of the set of pixels to respond to the corresponding data voltage provided by the data interconnect. The control matrix also includes at least one area modulation control interconnect for controlling the area modulation control logic.

### TECHNICAL FIELD

This disclosure relates to the field of electromechanical systems (EMS). In particular, this disclosure relates to circuits for controlling an array of EMS display elements of a field sequential type digital display apparatus.

### DESCRIPTION OF THE RELATED TECHNOLOGY

To create an image, display apparatus can utilize certain image formation processes that generate a sequence of separate subfield images, also referred to as “subframes,” which the human visual system (HVS) blends together to form a single image frame. These subframes can be associated with different weights to provide a coded gray scale process. This allows for an increase in the number of colors that may be generated with a reduced number of additional subframes. When relying on subframe duration to implement the weights, the number of subframes that are possible to display within the fixed period of time allocated to a single image frame, given a particular frame rate (e.g., 16.6 ms for a 60 Hz frame rate) is limited by the actuation speed of display elements and the time associated with addressing each display element in the display. Image quality can be improved, however, by increasing the number of subframes used to display a single image frame.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus that includes a set of pixels having at least two display elements configured to be controlled by a common data voltage. The apparatus also includes a control matrix having a single data interconnect that is configured to provide the data voltage for each pixel. The control matrix also includes area modulation control logic for selecting a number of display elements included in each pixel of the set of pixels to respond to the corresponding data voltage provided by the data interconnect. The control matrix also includes at least one area modulation control interconnect for controlling the area modulation control logic.

In some implementations, the area modulation control logic is configured to provide, for a first subframe, the corresponding data voltage to one of the at least two display elements and to provide, for a second subframe, the data voltage to two of the at least two display elements.

In some implementations, the area modulation control logic includes a first switch for selecting two display elements in each pixel of the set of pixels to respond to the corresponding data voltage provided by the data interconnect. In some implementations, the control logic includes a first switch and a second switch for selecting three display elements in each pixel of the set of pixels to respond to the corresponding data voltage provided by the data interconnect.

In some implementations, the area modulation control logic includes a first switch for selecting a first display element in each of the set of pixels to respond to the corresponding data voltage provided by the data interconnect and a second switch for selecting a second display element in each pixel of the set of pixels to respond to the corresponding data voltage provided by the data interconnect.

In some implementations, the at least one area modulation control interconnect includes a first area modulation control interconnect for controlling the first switch and a second area modulation control interconnect for controlling the second switch.

In some implementations, the at least two display elements are configured to achieve, at a given time, one of a closed state and an open state. In some such implementations, one of the at least two display elements has an area through which light is modulated that is two times as large as an area of an other of the at least two display elements through which light is modulated. In some implementations, the two display elements are configured to achieve, at a given time, one of n possible states to form an n-base digital display. In some such implementations, one of the at least two display elements has an area through which light is modulated that is n−1 times as large as an area of another of the at least two display elements through which light is modulated.

In some implementations, the at least two display elements include a first display element, a second display element and a third display element. Each of the display elements is configured to achieve, at a given time, a closed state and an open state. In some such implementations, the first display element has an area through which light is modulated that is two times as large as areas of the second and third display elements through which light is modulated.

In some implementations, the at least two display elements include m number of display elements and the apparatus is configured to implement an n-base weighting scheme. In such implementations, a ratio of areas of the display elements takes a form of 1, n−1, n²−n, n³−n², n⁴−n³, n⁵−n⁴, . . . n^{m-1}−n^{m-2}.

In some implementations, the display elements are electromechanical system (EMS) display elements. In some implementations, the display elements are microelectromechanical system (MEMS) display elements.

In some implementations, the apparatus includes a display, a processor that is configured to process image data and a memory device that is configured to communicate with the processor. In some implementations, the apparatus includes a driver circuit configured to send at least one signal to the display and the processor is further configured to send at least a portion of the image data to the driver circuit. In some implementations, the apparatus includes an image source module configured to send the image data to the processor. In some such implementations, the image source module includes at least one of a receiver, transceiver, and transmitter. In some implementations, the apparatus includes an input device configured to receive input data and to communicate the input data to the processor.

Another innovative aspect of the subject matter described in this disclosure can be implemented in a method for displaying images. The method includes selecting a number of display elements to respond to a corresponding data voltage provided by a single data source. The display elements correspond to a single pixel of a set of pixels. At least one area modulation control switch is activated to implement the selection of the number of display elements to respond to the corresponding data voltage. Next, a write-enabling voltage is provided to write-enabling switches corresponding to the display elements selected to respond to the corresponding data voltage. A corresponding data voltage is provided to each of the selected display elements and a light source is then activated to generate an image.

In some implementations, selecting a number of display elements to respond to a corresponding data voltage includes determining a weight of a subframe image to be displayed. In some implementations, activating at least one area modulation control switch includes applying a control voltage to the at least one area modulation control switch via an area modulation control interconnect.

In some implementations, the method includes causing the selected display elements to assume a first light-transmissive state upon providing a first data voltage and causing the selected display elements to assume a light-blocking state upon providing second data voltage.

Another innovative aspect of the subject matter described in this disclosure can be implemented in an apparatus for displaying images that includes a selection means for selecting, for a set of pixels, a number of display elements per pixel to respond to a corresponding data voltage provided by a single data source. The apparatus also includes at least one area modulation control means for implementing the selection of the number of display elements per pixel to respond to the corresponding data voltage. A write-enabling means for enabling the selected number of display elements per pixel to respond to the corresponding data voltage. The apparatus also includes a means for providing the corresponding data voltage to each of the selected display elements and a means for illuminating the set of pixels to generate an image.

In some implementations, selecting a number of display elements per pixel to respond to a corresponding data voltage includes determining a weight of a subframe to be displayed. In some implementations, the apparatus further includes an update means for causing the selected display elements to assume a first light-transmissive state upon providing a first data voltage and for causing the selected display elements to assume a light-blocking state upon providing a second data voltage.

Another innovative aspect of the subject matter described in this disclosure can be implemented in a processor-readable storage medium that has processor-executable instructions stored thereon. The instructions, when executed by a processor, cause the processor to select a number of display elements to respond to a corresponding data voltage provided by a single data source. The display elements correspond to a single pixel of a set of pixels. The instructions cause the processor to activate at least one area modulation control switch to implement the selection of the number of display elements to respond to the corresponding data voltage. The instructions further cause the processor to provide a write-enabling voltage to write-enabling switches corresponding to the display elements selected to respond to the corresponding data voltage. The instructions further cause the processor to provide a corresponding data voltage to each of the selected display elements and to activate a light source to generate an image.

In some implementations, selecting a number of display elements to respond to a corresponding data voltage includes determining a weight of a subframe image to be displayed. In some implementations, activating at least one area modulation control switch includes applying a control voltage to the at least one area modulation control switch via an area modulation control interconnect.

In some implementations, the processor-readable storage medium further includes instructions, which when executed by the processor, cause the processor to cause the selected display elements to assume a first light-transmissive state upon providing a first data voltage and causing the selected display elements to assume a light-blocking state upon providing a second data voltage.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays (LCDs), organic light emitting diode (OLED) displays, electrophoretic displays, and field emission displays, as well as to other non-display MEMS devices, such as MEMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows an example schematic diagram of a direct-view MEMS-based display apparatus.

FIG. 1B shows an example block diagram of a host device.

FIG. 2A shows an example perspective view of an illustrative shutter-based light modulator.

FIG. 2B shows a cross sectional view of a rolling actuator shutter-based light modulator.

FIG. 2C shows a cross sectional view of an illustrative non shutter-based microelectromechanical systems (MEMS) light modulator.

FIG. 2D shows a cross sectional view of an electrowetting-based light modulation array.

FIG. 3A shows an example schematic diagram of a control matrix.

FIG. 3B shows a perspective view of an array of shutter-based light modulators connected to the control matrix of FIG. 3A.

FIGS. 4A and 4B show example views of a dual actuator shutter assembly.

FIG. 5 shows a portion of an example control matrix.

FIG. 6A shows an example timing diagram of pixel intensity and lamp illumination.

FIGS. 6B and 6C show an example timing diagram of sub-pixel and pixel intensities and lamp illumination.

FIG. 7 shows a flow diagram of an example pixel actuation method.

FIGS. 8 and 9 show a portion of example control matrices.

FIG. 10 shows an example pixel of a display apparatus.

FIGS. 11A and 11B show system block diagrams illustrating a display device that includes a plurality of display elements.

Like reference numbers and designations in the various drawings indicate like elements.

### DETAILED DESCRIPTION

This disclosure relates to circuits and algorithms for improving image quality of images displayed by a display apparatus. To create an image, a display apparatus can utilize certain image formation processes that generate a sequence of separate subfield images, also referred to as “subframes,” which the human visual system (HVS) blends together to form a single image frame. These subframes can be associated with different weights to provide a coded gray scale process. This allows for an increase in the number of colors that may be generated with a reduced number of additional subframes.

The weights of subframes can be implemented utilizing both temporal modulation and spatial modulation. The weights of subframes can be implemented using spatial modulation by modulating the possible area through which light is transmitted for each pixel, subframe-by-subframe. To provide such spatial modulation, a display apparatus can include a set of pixels that each has at least two display elements that can be controlled with a single data interconnect to modulate light being output by the display in association with that pixel. In some implementations, the display elements are electromechanical systems (EMS) devices, such as nanoelectromechanical systems (NEMS) devices, microelectromechanical systems (MEMS) devices or larger scale light modulators. In some other implementations, each pixel can include multiple light emitters, such as organic light emitting diodes (OLEDs). In such implementations, the intensity of each emitter in a given pixel is set by a single data interconnect. The display apparatus also includes area modulation control logic, including, for example, area modulation control switches, for selecting a number of display elements in each pixel that are to respond to a provided data voltage. Corresponding area modulation control interconnects can be used to control the switches.

By selecting the number of display elements in each pixel that respond to data in each subframe, the display apparatus is able to modulate the weight of each subframe without altering the duration for which the subframe is illuminated or the intensity at which it is illuminated.

Particular implementations of the subject matter described in this disclosure can be implemented to realize one or more of the following potential advantages. First, by providing the ability to implement spatial-temporal mixed modulation, the formation of image artifacts are reduced due to the flexibility offered by spatial-temporal mixed modulation when compared to image artifacts that are formed as a result of pure temporal modulation or pure spatial modulation. In particular, time can be saved by implementing subframe weights using a spatial-temporal mixed modulation instead of a pure temporal modulation. This time saving can be used to allow a display apparatus to increase the number of subframes it displays for an image frame without increasing the amount of time allocated to the frame. By increasing the number of subframes displayed for a given image frame without increasing the amount of time needed to display them, the display apparatus can display images with improved image quality. In particular, by increasing the subframe rate, the display apparatus can provide more colors or provide more opportunity for redundant subframes to reduce the formation of image artifacts. In particular, the formation of image artifacts caused by color breakup can be reduced.

Alternatively, in some implementations, by employing some degree of spatial modulation instead of temporal modulation, instead of displaying additional subframes within a given image frame duration, the same number of subframes can be displayed using lower light source intensity, resulting in reduced power consumption. Further, in some implementations, by employing some degree of spatial modulation instead of temporal modulation, flicker can be reduced by displaying the same number of subframes, while increasing the frame rate. Moreover, because the area modulation control switches can be configured to control entire rows or columns of pixels at a time, and a large number, if not all, of the area modulation control switches can be controlled by one or a relatively small number of area modulation control interconnects, the addition of this feature requires a relatively small amount of substrate real estate to implement. In addition, the simplified circuit structure has the potential to reduce the backplane power consumption in comparison to other sub-pixel type approaches.

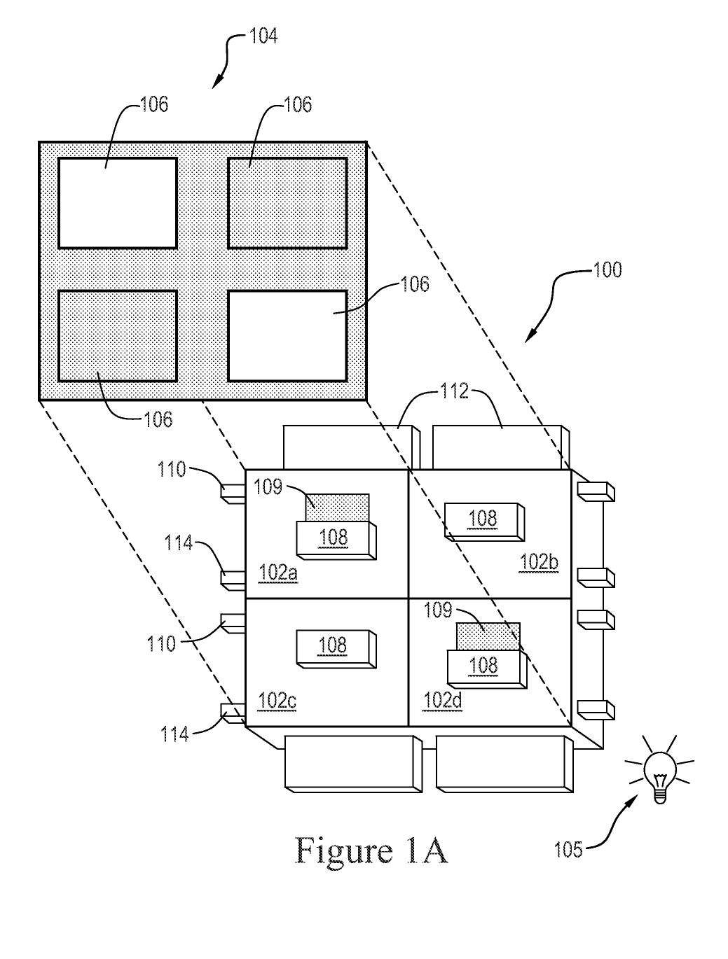

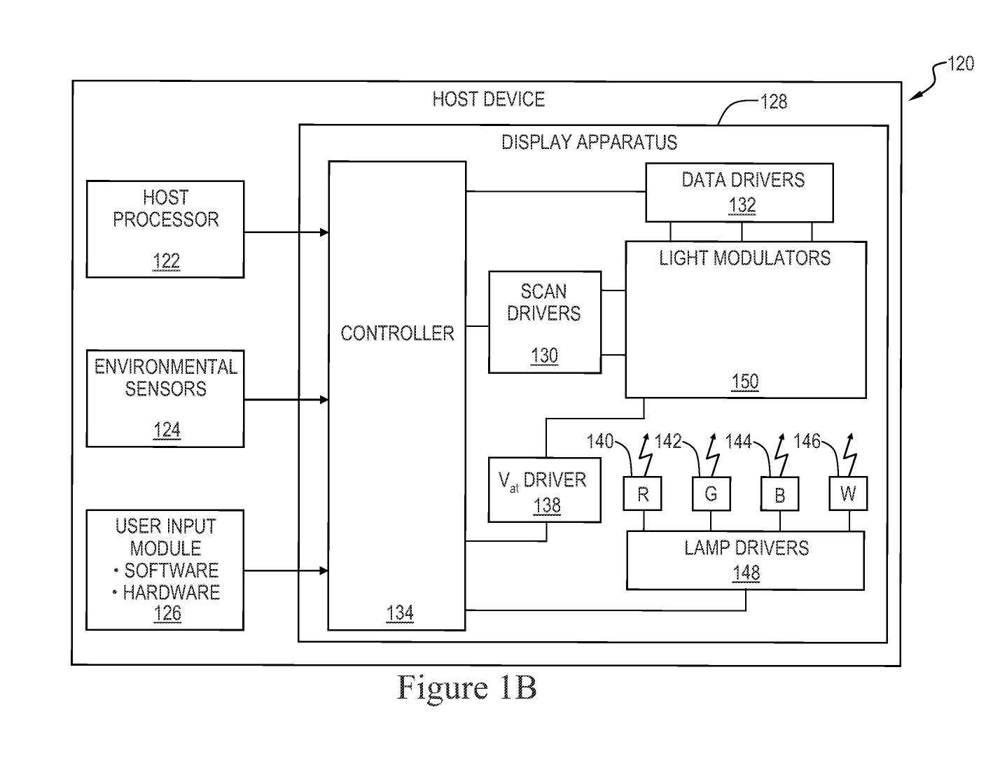

FIG. 1A shows a schematic diagram of a direct-view MEMS-based display apparatus 100. The display apparatus 100 includes a plurality of light modulators 102a-102d (generally “light modulators 102”) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide luminance level in an image 104. With respect to an image, a “pixel” corresponds to the smallest picture element defined by the resolution of image. With respect to structural components of the display apparatus 100, the term “pixel” refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the user sees the image by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or “backlight” so that each pixel can be uniformly illuminated. Transmissive direct-view displays are often built onto transparent or glass substrates to facilitate a sandwich assembly arrangement where one substrate, containing the light modulators, is positioned directly on top of the backlight.

Each light modulator 102 can include a shutter 108 and an aperture 109. To illuminate a pixel 106 in the image 104, the shutter 108 is positioned such that it allows light to pass through the aperture 109 towards a viewer. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix connected to the substrate and to the light modulators for controlling the movement of the shutters. The control matrix includes a series of electrical interconnects (for example, interconnects 110, 112 and 114), including at least one write-enable interconnect 110 (also referred to as a “scan-line interconnect”) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the “write-enabling voltage, V_{WE}”), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, for example, transistors or other non-linear circuit elements that control the application of separate actuation voltages, which are typically higher in magnitude than the data voltages, to the light modulators 102. The application of these actuation voltages then results in the electrostatic driven movement of the shutters 108.

FIG. 1B shows an example of a block diagram of a host device 120 (i.e., cell phone, smart phone, PDA, MP3 player, tablet, e-reader, etc.). The host device 120 includes a display apparatus 128, a host processor 122, environmental sensors 124, a user input module 126, and a power source.

The display apparatus 128 includes a plurality of scan drivers 130 (also referred to as “write enabling voltage sources”), a plurality of data drivers 132 (also referred to as “data voltage sources”), a controller 134, common drivers 138, lamps 140-146, lamp drivers 148 and an array 150 of display elements, such as the light modulators 102 shown in FIG. 1A. The scan drivers 130 apply write enabling voltages to scan-line interconnects 110. The data drivers 132 apply data voltages to the data interconnects 112.

In some implementations of the display apparatus, the data drivers 132 are configured to provide analog data voltages to the array 150 of display elements, especially where the luminance level of the image 104 is to be derived in analog fashion. In analog operation, the light modulators 102 are designed such that when a range of intermediate voltages is applied through the data interconnects 112, there results a range of intermediate open states in the shutters 108 and therefore a range of intermediate illumination states or luminance levels in the image 104. In other cases, the data drivers 132 are configured to apply only a reduced set of 2, 3 or 4 digital voltage levels to the data interconnects 112. These voltage levels are designed to set, in digital fashion, an open state, a closed state, or other discrete state to each of the shutters 108.

The scan drivers 130 and the data drivers 132 are connected to a digital controller circuit 134 (also referred to as the “controller 134”). The controller sends data to the data drivers 132 in a mostly serial fashion, organized in predetermined sequences grouped by rows and by image frames. The data drivers 132 can include series to parallel data converters, level shifting, and for some applications digital to analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 114. In some other implementations, the common drivers 138, following commands from the controller 134, issue voltage pulses or signals to the array 150 of display elements, for instance global actuation pulses which are capable of driving and/or initiating simultaneous actuation of all display elements in multiple rows and columns of the array 150.

All of the drivers (for example, scan drivers 130, data drivers 132 and common drivers 138) for different display functions are time-synchronized by the controller 134. Timing commands from the controller coordinate the illumination of red, green and blue and white lamps (140, 142, 144 and 146 respectively) via lamp drivers 148, the write-enabling and sequencing of specific rows within the array 150 of display elements, the output of voltages from the data drivers 132, and the output of voltages that provide for display element actuation.

The controller 134 determines the sequencing or addressing scheme by which each of the shutters 108 can be re-set to the illumination levels appropriate to a new image 104. New images 104 can be set at periodic intervals. For instance, for video displays, the color images 104 or frames of video are refreshed at frequencies ranging from 10 to 300 Hertz (Hz). In some implementations the setting of an image frame to the array 150 is synchronized with the illumination of the lamps 140, 142, 144 and 146 such that alternate image frames are illuminated with an alternating series of colors, such as red, green, and blue. The image frames for each respective color is referred to as a color subframe. In this method, referred to as the field sequential color method, if the color subframes are alternated at frequencies in excess of 20 Hz, the human brain will average the alternating frame images into the perception of an image having a broad and continuous range of colors. In alternate implementations, four or more lamps with primary colors can be employed in display apparatus 100, employing primaries other than red, green, and blue.

In some implementations, where the display apparatus 100 is designed for the digital switching of shutters 108 between open and closed states, the controller 134 forms an image by the method of time division gray scale, as previously described. In some other implementations, the display apparatus 100 can provide gray scale through the use of multiple shutters 108 per pixel.

In some implementations, the data for an image state 104 is loaded by the controller 134 to the display element array 150 by a sequential addressing of individual rows, also referred to as scan lines. For each row or scan line in the sequence, the scan driver 130 applies a write-enable voltage to the write enable interconnect 110 for that row of the array 150, and subsequently the data driver 132 supplies data voltages, corresponding to desired shutter states, for each column in the selected row. This process repeats until data has been loaded for all rows in the array 150. In some implementations, the sequence of selected rows for data loading is linear, proceeding from top to bottom in the array 150. In some other implementations, the sequence of selected rows is pseudo-randomized, in order to minimize visual artifacts. And in some other implementations the sequencing is organized by blocks, where, for a block, the data for only a certain fraction of the image state 104 is loaded to the array 150, for instance by addressing only every 5^{th} row of the array 150 in sequence.

In alternative implementations, the array 150 of display elements and the control matrix that controls the display elements may be arranged in configurations other than rectangular rows and columns. For example, the display elements can be arranged in hexagonal arrays or curvilinear rows and columns. In general, as used herein, the term scan-line shall refer to any plurality of display elements that share a write-enabling interconnect.

The host processor 122 generally controls the operations of the host. For example, the host processor 122 may be a general or special purpose processor for controlling a portable electronic device. With respect to the display apparatus 128, included within the host device 120, the host processor 122 outputs image data as well as additional data about the host. Such information may include data from environmental sensors, such as ambient light or temperature; information about the host, including, for example, an operating mode of the host or the amount of power remaining in the host's power source; information about the content of the image data; information about the type of image data; and/or instructions for display apparatus for use in selecting an imaging mode.

The user input module 126 conveys the personal preferences of the user to the controller 134, either directly, or via the host processor 122. In some implementations, the user input module 126 is controlled by software in which the user programs personal preferences such as “deeper color,” “better contrast,” “lower power,” “increased brightness,” “sports,” “live action,” or “animation.” In some other implementations, these preferences are input to the host using hardware, such as a switch or dial. The plurality of data inputs to the controller 134 direct the controller to provide data to the various drivers 130, 132, 138 and 148 which correspond to optimal imaging characteristics.

An environmental sensor module 124 also can be included as part of the host device 120. The environmental sensor module 124 receives data about the ambient environment, such as temperature and or ambient lighting conditions. The sensor module 124 can be programmed to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

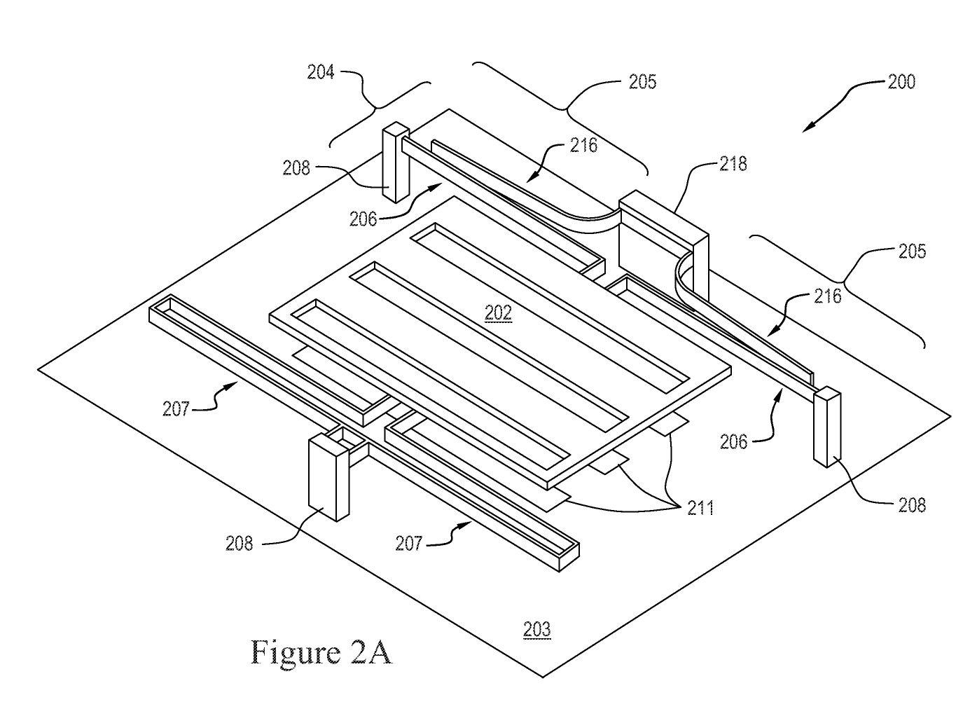

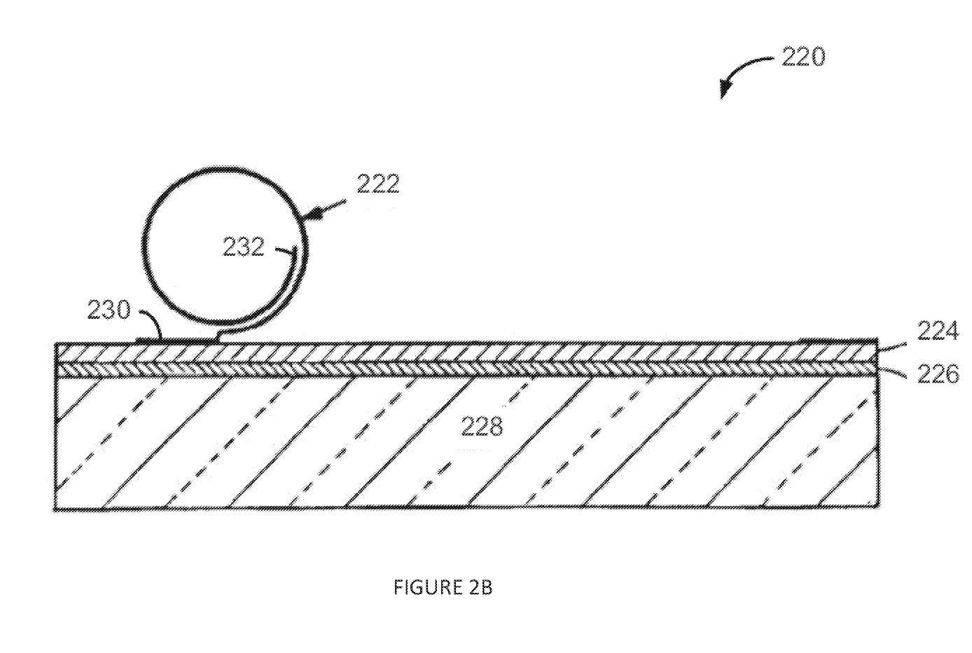

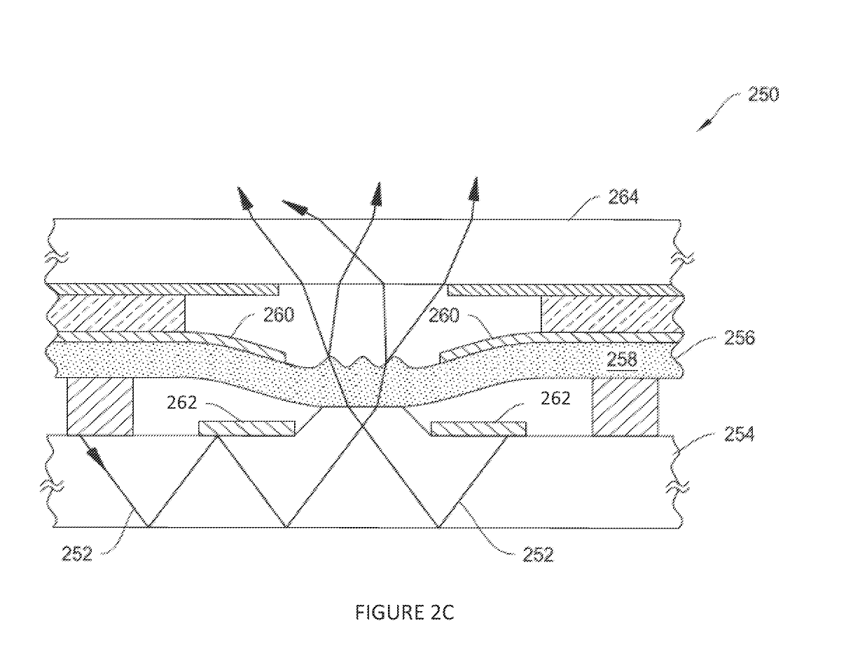

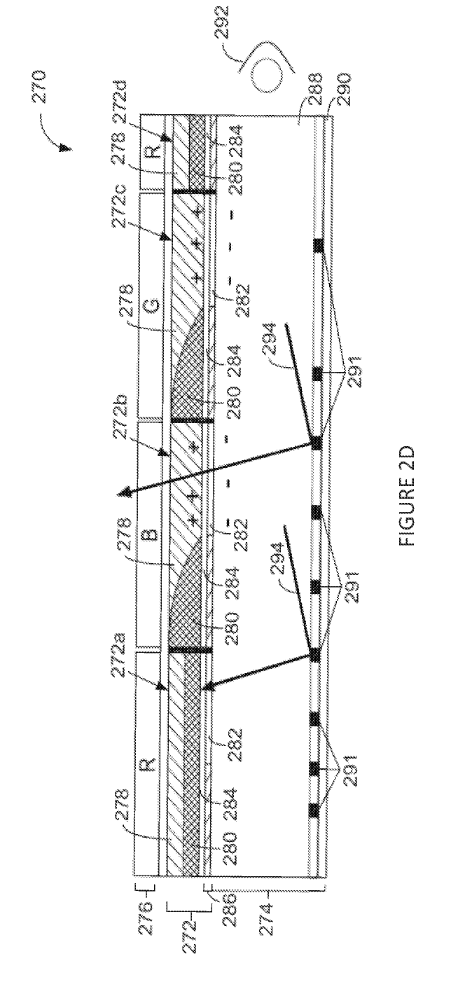

FIG. 2A shows a perspective view of an illustrative shutter-based light modulator 200. The shutter-based light modulator 200 is suitable for incorporation into the direct-view MEMS-based display apparatus 100 of FIG. 1A. The light modulator 200 includes a shutter 202 coupled to an actuator 204. The actuator 204 can be formed from two separate compliant electrode beam actuators 205 (the “actuators 205”). The shutter 202 couples on one side to the actuators 205. The actuators 205 move the shutter 202 transversely over a surface 203 in a plane of motion which is substantially parallel to the surface 203. The opposite side of the shutter 202 couples to a spring 207 which provides a restoring force opposing the forces exerted by the actuator 204.

Each actuator 205 includes a compliant load beam 206 connecting the shutter 202 to a load anchor 208. The load anchors 208 along with the compliant load beams 206 serve as mechanical supports, keeping the shutter 202 suspended proximate to the surface 203. The surface 203 includes one or more aperture holes 211 for admitting the passage of light. The load anchors 208 physically connect the compliant load beams 206 and the shutter 202 to the surface 203 and electrically connect the load beams 206 to a bias voltage, in some instances, ground.

If the substrate is opaque, such as silicon, then aperture holes 211 are formed in the substrate by etching an array of holes through the substrate 204. If the substrate 204 is transparent, such as glass or plastic, then the aperture holes 211 are formed in a layer of light-blocking material deposited on the substrate 203. The aperture holes 211 can be generally circular, elliptical, polygonal, serpentine, or irregular in shape.

Each actuator 205 also includes a compliant drive beam 216 positioned adjacent to each load beam 206. The drive beams 216 couple at one end to a drive beam anchor 218 shared between the drive beams 216. The other end of each drive beam 216 is free to move. Each drive beam 216 is curved such that it is closest to the load beam 206 near the free end of the drive beam 216 and the anchored end of the load beam 206.

In operation, a display apparatus incorporating the light modulator 200 applies an electric potential to the drive beams 216 via the drive beam anchor 218. A second electric potential may be applied to the load beams 206. The resulting potential difference between the drive beams 216 and the load beams 206 pulls the free ends of the drive beams 216 towards the anchored ends of the load beams 206, and pulls the shutter ends of the load beams 206 toward the anchored ends of the drive beams 216, thereby driving the shutter 202 transversely toward the drive anchor 218. The compliant members 206 act as springs, such that when the voltage across the beams 206 and 216 potential is removed, the load beams 206 push the shutter 202 back into its initial position, releasing the stress stored in the load beams 206.

A light modulator, such as the light modulator 200, incorporates a passive restoring force, such as a spring, for returning a shutter to its rest position after voltages have been removed. Other shutter assemblies can incorporate a dual set of “open” and “closed” actuators and a separate set of “open” and “closed” electrodes for moving the shutter into either an open or a closed state.

There are a variety of methods by which an array of shutters and apertures can be controlled via a control matrix to produce images, in many cases moving images, with appropriate luminance levels. In some cases, control is accomplished by means of a passive matrix array of row and column interconnects connected to driver circuits on the periphery of the display. In other cases it is appropriate to include switching and/or data storage elements within each pixel of the array (the so-called active matrix) to improve the speed, the luminance level and/or the power dissipation performance of the display.

The display apparatus 100, in alternative implementations, includes display elements other than transverse shutter-based light modulators, such as the shutter assembly 200 described above. For example, FIG. 2B shows a cross sectional view of a rolling actuator shutter-based light modulator 220. The rolling actuator shutter-based light modulator 220 is suitable for incorporation into an alternative implementation of the MEMS-based display apparatus 100 of FIG. 1A. A rolling actuator-based light modulator includes a movable electrode disposed opposite a fixed electrode and biased to move in a particular direction to function as a shutter upon application of an electric field. In some implementations, the light modulator 220 includes a planar electrode 226 disposed between a substrate 228 and an insulating layer 224 and a movable electrode 222 having a fixed end 230 attached to the insulating layer 224. In the absence of any applied voltage, a movable end 232 of the movable electrode 222 is free to roll towards the fixed end 230 to produce a rolled state. Application of a voltage between the electrodes 222 and 226 causes the movable electrode 222 to unroll and lie flat against the insulating layer 224, whereby it acts as a shutter that blocks light traveling through the substrate 228. The movable electrode 222 returns to the rolled state by means of an elastic restoring force after the voltage is removed. The bias towards a rolled state may be achieved by manufacturing the movable electrode 222 to include an anisotropic stress state.

FIG. 2C shows a cross sectional view of an illustrative non shutter-based MEMS light modulator 250. The light tap modulator 250 is suitable for incorporation into an alternative implementation of the MEMS-based display apparatus 100 of FIG. 1A. A light tap works according to a principle of frustrated total internal reflection (TIR). That is, light 252 is introduced into a light guide 254, in which, without interference, light 252 is, for the most part, unable to escape the light guide 254 through its front or rear surfaces due to TIR. The light tap 250 includes a tap element 256 that has a sufficiently high index of refraction that, in response to the tap element 256 contacting the light guide 254, the light 252 impinging on the surface of the light guide 254 adjacent the tap element 256 escapes the light guide 254 through the tap element 256 towards a viewer, thereby contributing to the formation of an image.

In some implementations, the tap element 256 is formed as part of a beam 258 of flexible, transparent material. Electrodes 260 coat portions of one side of the beam 258. Opposing electrodes 262 are disposed on the light guide 254. By applying a voltage across the electrodes 260 and 262, the position of the tap element 256 relative to the light guide 254 can be controlled to selectively extract light 252 from the light guide 254.

FIG. 2D shows an example cross sectional view of an electrowetting-based light modulation array 270. The electrowetting-based light modulation array 270 is suitable for incorporation into an alternative implementation of the MEMS-based display apparatus 100 of FIG. 1A. The light modulation array 270 includes a plurality of electrowetting-based light modulation cells 272a-272d (generally “cells 272”) formed on an optical cavity 274. The light modulation array 270 also includes a set of color filters 276 corresponding to the cells 272.

Each cell 272 includes a layer of water (or other transparent conductive or polar fluid) 278, a layer of light absorbing oil 280, a transparent electrode 282 (made, for example, from indium-tin oxide (ITO)) and an insulating layer 284 positioned between the layer of light absorbing oil 280 and the transparent electrode 282. In the implementation described herein, the electrode takes up a portion of a rear surface of a cell 272.

The remainder of the rear surface of a cell 272 is formed from a reflective aperture layer 286 that forms the front surface of the optical cavity 274. The reflective aperture layer 286 is formed from a reflective material, such as a reflective metal or a stack of thin films forming a dielectric mirror. For each cell 272, an aperture is formed in the reflective aperture layer 286 to allow light to pass through. The electrode 282 for the cell is deposited in the aperture and over the material forming the reflective aperture layer 286, separated by another dielectric layer.

The remainder of the optical cavity 274 includes a light guide 288 positioned proximate the reflective aperture layer 286, and a second reflective layer 290 on a side of the light guide 288 opposite the reflective aperture layer 286. A series of light redirectors 291 are formed on the rear surface of the light guide, proximate the second reflective layer. The light redirectors 291 may be either diffuse or specular reflectors. One or more light sources 292, such as LEDs, inject light 294 into the light guide 288.

In an alternative implementation, an additional transparent substrate (not shown) is positioned between the light guide 288 and the light modulation array 270. In this implementation, the reflective aperture layer 286 is formed on the additional transparent substrate instead of on the surface of the light guide 288.

In operation, application of a voltage to the electrode 282 of a cell (for example, cell 272b or 272c) causes the light absorbing oil 280 in the cell to collect in one portion of the cell 272. As a result, the light absorbing oil 280 no longer obstructs the passage of light through the aperture formed in the reflective aperture layer 286 (see, for example, cells 272b and 272c). Light escaping the backlight at the aperture is then able to escape through the cell and through a corresponding color filter (for example, red, green or blue) in the set of color filters 276 to form a color pixel in an image. When the electrode 282 is grounded, the light absorbing oil 280 covers the aperture in the reflective aperture layer 286, absorbing any light 294 attempting to pass through it.

The area under which oil 280 collects when a voltage is applied to the cell 272 constitutes wasted space in relation to forming an image. This area is non-transmissive, whether a voltage is applied or not. Therefore, without the inclusion of the reflective portions of reflective apertures layer 286, this area absorbs light that otherwise could be used to contribute to the formation of an image. However, with the inclusion of the reflective aperture layer 286, this light, which otherwise would have been absorbed, is reflected back into the light guide 290 for future escape through a different aperture. The electrowetting-based light modulation array 270 is not the only example of a non-shutter-based MEMS modulator suitable for inclusion in the display apparatus described herein. Other forms of non-shutter-based MEMS modulators could likewise be controlled by various ones of the controller functions described herein without departing from the scope of this disclosure.

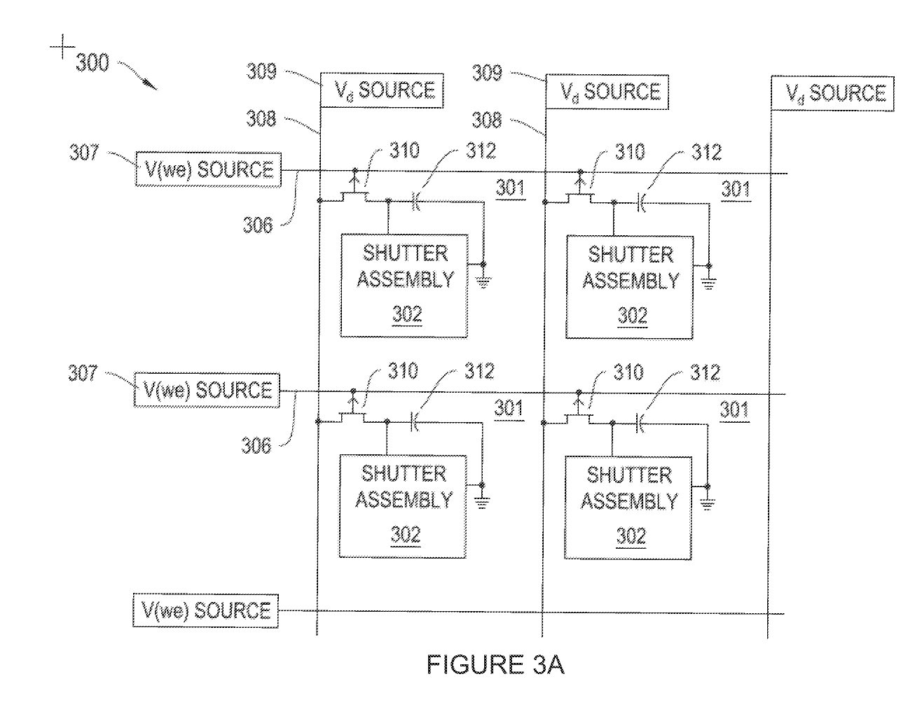

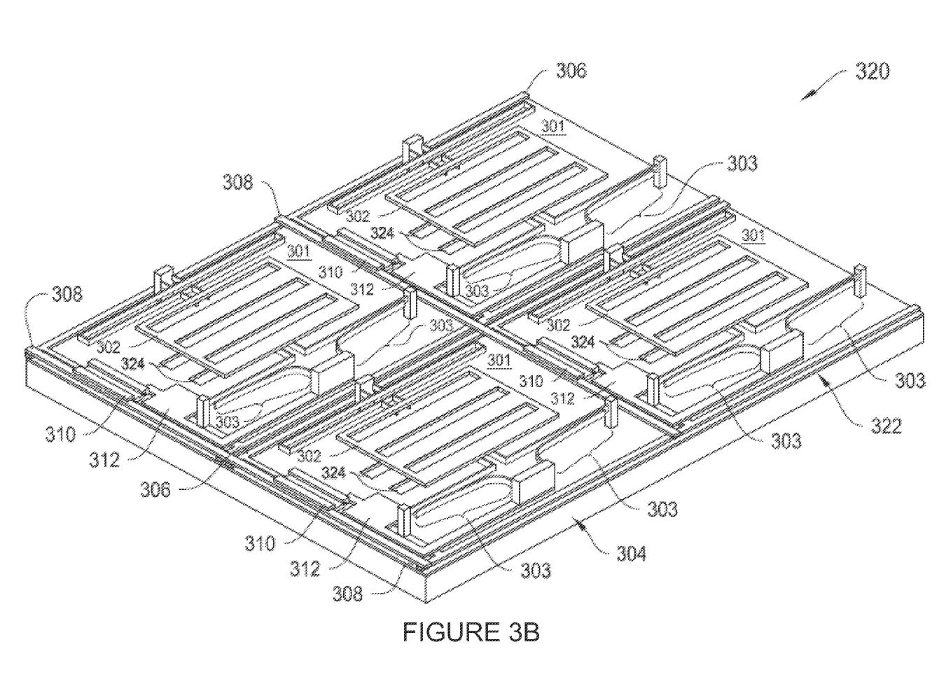

FIG. 3A shows an example schematic diagram of a control matrix 300. The control matrix 300 is suitable for controlling the light modulators incorporated into the MEMS-based display apparatus 100 of FIG. 1A. FIG. 3B shows a perspective view of an array 320 of shutter-based light modulators connected to the control matrix 300 of FIG. 3A. The control matrix 300 may address an array of pixels 320 (the “array 320”). Each pixel 301 can include an elastic shutter assembly 302, such as the shutter assembly 200 of FIG. 2A, controlled by an actuator 303. Each pixel also can include an aperture layer 322 that includes apertures 324.

The control matrix 300 is fabricated as a diffused or thin-film-deposited electrical circuit on the surface of a substrate 304 on which the shutter assemblies 302 are formed. The control matrix 300 includes a scan-line interconnect 306 for each row of pixels 301 in the control matrix 300 and a data-interconnect 308 for each column of pixels 301 in the control matrix 300. Each scan-line interconnect 306 electrically connects a write-enabling voltage source 307 to the pixels 301 in a corresponding row of pixels 301. Each data interconnect 308 electrically connects a data voltage source 309 (“V_{d} source”) to the pixels 301 in a corresponding column of pixels. In the control matrix 300, the V_{d} source 309 provides the majority of the energy to be used for actuation of the shutter assemblies 302. Thus, the data voltage source, V_{d} source 309, also serves as an actuation voltage source.

Referring to FIGS. 3A and 3B, for each pixel 301 or for each shutter assembly 302 in the array of pixels 320, the control matrix 300 includes a transistor 310 and a capacitor 312. The gate of each transistor 310 is electrically connected to the scan-line interconnect 306 of the row in the array 320 in which the pixel 301 is located. The source of each transistor 310 is electrically connected to its corresponding data interconnect 308. The actuators 303 of each shutter assembly 302 include two electrodes. The drain of each transistor 310 is electrically connected in parallel to one electrode of the corresponding capacitor 312 and to one of the electrodes of the corresponding actuator 303. The other electrode of the capacitor 312 and the other electrode of the actuator 303 in shutter assembly 302 are connected to a common or ground potential. In alternate implementations, the transistors 310 can be replaced with semiconductor diodes and or metal-insulator-metal sandwich type switching elements.

In operation, to form an image, the control matrix 300 write-enables each row in the array 320 in a sequence by applying V_{we} to each scan-line interconnect 306 in turn. For a write-enabled row, the application of V_{we} to the gates of the transistors 310 of the pixels 301 in the row allows the flow of current through the data interconnects 308 through the transistors 310 to apply a potential to the actuator 303 of the shutter assembly 302. While the row is write-enabled, data voltages V_{d} are selectively applied to the data interconnects 308. In implementations providing analog gray scale, the data voltage applied to each data interconnect 308 is varied in relation to the desired brightness of the pixel 301 located at the intersection of the write-enabled scan-line interconnect 306 and the data interconnect 308. In implementations providing digital control schemes, the data voltage is selected to be either a relatively low magnitude voltage (i.e., a voltage near ground) or to meet or exceed Vₐₜ (the actuation threshold voltage). In response to the application of Vₐₜ to a data interconnect 308, the actuator 303 in the corresponding shutter assembly actuates, opening the shutter in that shutter assembly 302. The voltage applied to the data interconnect 308 remains stored in the capacitor 312 of the pixel 301 even after the control matrix 300 ceases to apply V_{we} to a row. Therefore, the voltage V_{we} does not have to wait and hold on a row for times long enough for the shutter assembly 302 to actuate; such actuation can proceed after the write-enabling voltage has been removed from the row. The capacitors 312 also function as memory elements within the array 320, storing actuation instructions for the illumination of an image frame.

The pixels 301 as well as the control matrix 300 of the array 320 are formed on a substrate 304. The array 320 includes an aperture layer 322, disposed on the substrate 304, which includes a set of apertures 324 for respective pixels 301 in the array 320. The apertures 324 are aligned with the shutter assemblies 302 in each pixel. In some implementations, the substrate 304 is made of a transparent material, such as glass or plastic. In some other implementations, the substrate 304 is made of an opaque material, but in which holes are etched to form the apertures 324.

The shutter assembly 302 together with the actuator 303 can be made bi-stable. That is, the shutters can exist in at least two equilibrium positions (for example, open or closed) with little or no power required to hold them in either position. More particularly, the shutter assembly 302 can be mechanically bi-stable. Once the shutter of the shutter assembly 302 is set in position, no electrical energy or holding voltage is required to maintain that position. The mechanical stresses on the physical elements of the shutter assembly 302 can hold the shutter in place.

The shutter assembly 302 together with the actuator 303 also can be made electrically bi-stable. In an electrically bi-stable shutter assembly, there exists a range of voltages below the actuation voltage of the shutter assembly, which if applied to a closed actuator (with the shutter being either open or closed), holds the actuator closed and the shutter in position, even if an opposing force is exerted on the shutter. The opposing force may be exerted by a spring such as the spring 207 in the shutter-based light modulator 200 depicted in FIG. 2A, or the opposing force may be exerted by an opposing actuator, such as an “open” or “closed” actuator.

The light modulator array 320 is depicted as having a single MEMS light modulator per pixel. Other implementations are possible in which multiple MEMS light modulators are provided in each pixel, thereby providing the possibility of more than just binary “on” or “off” optical states in each pixel. Certain forms of coded area division gray scale are possible where multiple MEMS light modulators in the pixel are provided, and where apertures 324, which are associated with each of the light modulators, have unequal areas.

In some other implementations, the roller-based light modulator 220, the light tap 250, or the electrowetting-based light modulation array 270, as well as other MEMS-based light modulators, can be substituted for the shutter assembly 302 within the light modulator array 320.

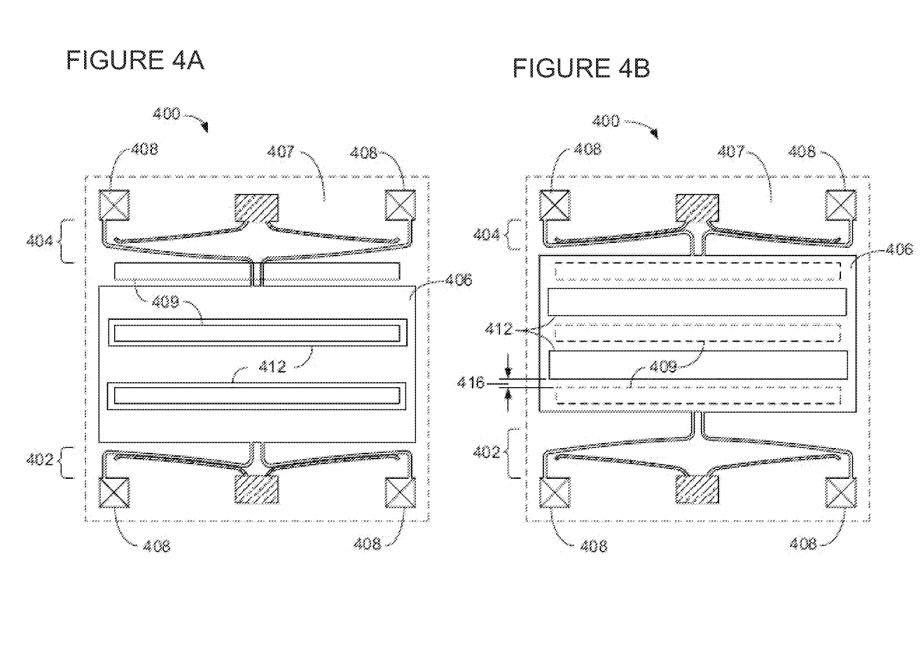

FIGS. 4A and 4B show example views of a dual actuator shutter assembly 400. The dual actuator shutter assembly 400, as depicted in FIG. 4A, is in an open state. FIG. 4B shows the dual actuator shutter assembly 400 in a closed state. In contrast to the shutter assembly 200, the shutter assembly 400 includes actuators 402 and 404 on either side of a shutter 406. Each actuator 402 and 404 is independently controlled. A first actuator, a shutter-open actuator 402, serves to open the shutter 406. A second opposing actuator, the shutter-close actuator 404, serves to close the shutter 406. Both of the actuators 402 and 404 are compliant beam electrode actuators. The actuators 402 and 404 open and close the shutter 406 by driving the shutter 406 substantially in a plane parallel to an aperture layer 407 over which the shutter is suspended. The shutter 406 is suspended a short distance over the aperture layer 407 by anchors 408 attached to the actuators 402 and 404. The inclusion of supports attached to both ends of the shutter 406 along its axis of movement reduces out of plane motion of the shutter 406 and confines the motion substantially to a plane parallel to the substrate. As will be described below, a variety of different control matrices may be used with the shutter assembly 400.

The shutter 406 includes two shutter apertures 412 through which light can pass. The aperture layer 407 includes a set of three apertures 409. In FIG. 4A, the shutter assembly 400 is in the open state and, as such, the shutter-open actuator 402 has been actuated, the shutter-close actuator 404 is in its relaxed position, and the centerlines of the shutter apertures 412 coincide with the centerlines of two of the aperture layer apertures 409. In FIG. 4B, the shutter assembly 400 has been moved to the closed state and, as such, the shutter-open actuator 402 is in its relaxed position, the shutter-close actuator 404 has been actuated, and the light blocking portions of the shutter 406 are now in position to block transmission of light through the apertures 409 (depicted as dotted lines).

Each aperture has at least one edge around its periphery. For example, the rectangular apertures 409 have four edges. In alternative implementations in which circular, elliptical, oval, or other curved apertures are formed in the aperture layer 407, each aperture may have only a single edge. In some other implementations, the apertures need not be separated or disjoint in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through apertures 412 and 409 in the open state, it is advantageous to provide a width or size for shutter apertures 412 which is larger than a corresponding width or size of apertures 409 in the aperture layer 407. In order to effectively block light from escaping in the closed state, it is preferable that the light blocking portions of the shutter 406 overlap the apertures 409. FIG. 4B shows a predefined overlap 416 between the edge of light blocking portions in the shutter 406 and one edge of the aperture 409 formed in the aperture layer 407.

The electrostatic actuators 402 and 404 are designed so that their voltage-displacement behavior provides a bi-stable characteristic to the shutter assembly 400. For each of the shutter-open and shutter-close actuators, there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

To increase the number of subframes that can be displayed within a given time period to generate an image frame, a display apparatus can implement the weights of subframes by utilizing both temporal modulation and spatial modulation. The weights of subframes can be implemented using spatial modulation by modulating the possible area through which light is transmitted for each pixel, subframe-by-subframe. To provide such spatial modulation, a display apparatus can include a set of pixels that each have at least two display elements that can be controlled with a single data interconnect to modulate light being output by the display in association with that pixel.

In some implementations, a display apparatus may include a set of pixels having multiple display elements. Area modulation control logic selects, for each subframe, a number of the display elements in each pixel that are to respond to a provided data voltage. Each of the display elements in a single pixel may respond to a data voltage provided by a single data source.

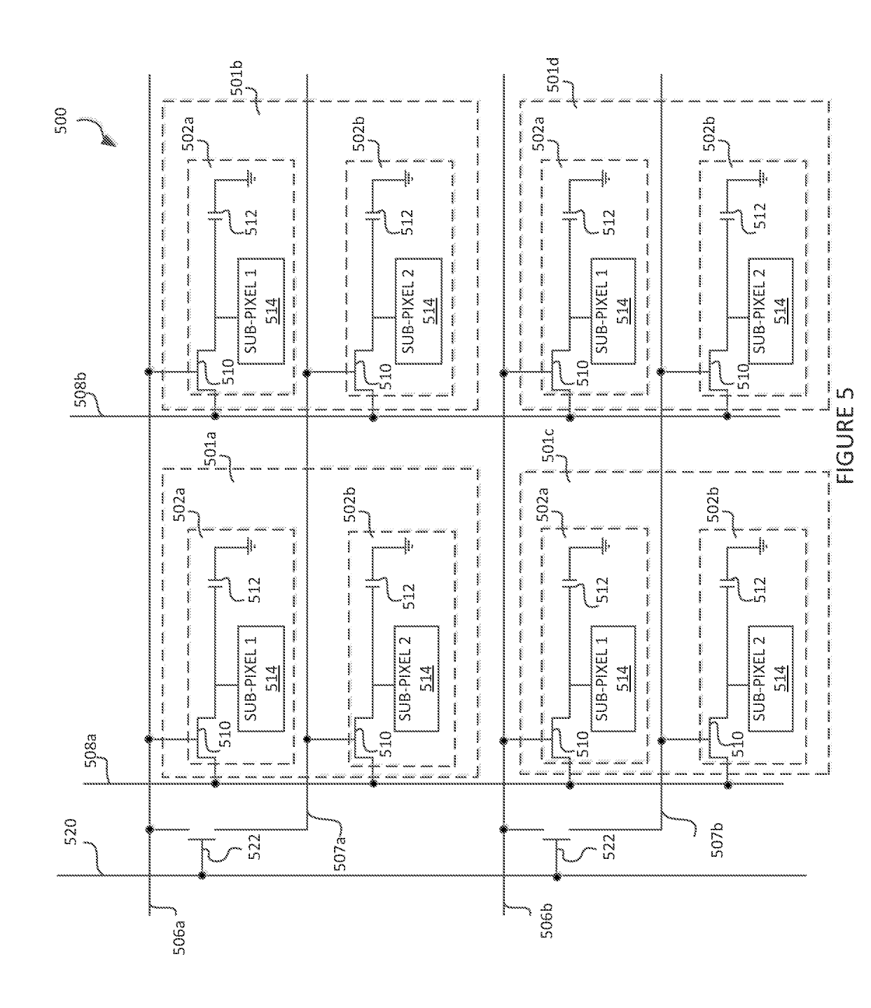

FIG. 5 shows a portion of an example control matrix 500. The control matrix 500 includes an array of pixels 501a-501d (generally “pixels 501”). The array of pixels 501a-501d are arranged in rows and columns, such that a first row of pixels 501 includes pixel 501a and pixel 501b and a second row of pixels 501 includes pixel 501c and pixel 501d. Similarly, a first column of pixels 501 includes pixel 501a and pixel 501c and a second column of pixels 501 includes pixel 501b and pixel 501d. The control matrix 500 also includes a plurality of data interconnects 508a and 508b (generally “data interconnects 508”), each corresponding to a respective column of pixels.

The control matrix 500 includes, for each row of pixels 501, a corresponding primary scan-line interconnect 506. For example, the control matrix 500 includes a first primary scan-line interconnect 506a corresponding to the first row of pixels and a second primary scan-line interconnect 506b corresponding to the second row of pixels. The control matrix 500 also includes a corresponding secondary scan-line interconnect 507 for each row of pixels. For example, the control matrix includes a first secondary scan-line interconnect 507a corresponding to the first row of pixels and a second secondary scan-line interconnect 507b corresponding to the second row of pixels.

In addition, the control matrix 500 includes a plurality of area modulation control switches 522 that are controlled by a common area modulation control interconnect 520, which are shared by multiple rows of pixels. In some other implementations, the area modulation control interconnect 520 can provide the same control voltage to pixels corresponding to multiple columns of the display apparatus. In some implementations, each of the area modulation control switches 522 is configured to control the write-enabling voltage applied to a corresponding secondary scan-line interconnect 507 for a given row of pixels.

Each pixel 501 includes a first sub-pixel 502a and a second sub-pixel 502b (generally “sub-pixel 502”). Each sub-pixel 502 includes a write-enabling switch 510, a data store capacitor 512 and a display element 514. The display element 514 includes a light modulator. The light modulator includes a light blocking element, such as a shutter. In some implementations, each of the display elements 514 corresponding to a pixel 501 may be configured to modulate an equal amount of light. This can be achieved, for example, by having display elements that include equally sized light modulating components. In some other implementations, however, the light modulating components of the display elements 514 may be unequal in size. In such implementations, the amount of light modulated by each of the display elements 514 may be different.

The write-enabling switch 510 in a sub-pixel 502 can be a transistor having a drain terminal connected to a data interconnect 508, a gate terminal connected to a corresponding primary or secondary scan-line interconnect 506 or 507 and a source terminal connected to the data store capacitor 512 and the display element 514 of the sub-pixel 502. If the write-enabling switch 510 is an NMOS transistor, when a write-enabling voltage greater than a threshold voltage of the transistor is applied to the gate terminal, the data voltage applied to the data interconnect 508 is stored at the data store capacitor 512. In this way, the sub-pixels 502 can be loaded with a data voltage.

As described above, the states of the area modulation control switches 522 control whether the second sub-pixels 502b in a row of pixels 501 respond to the data voltage applied via the data interconnects 508. The states of the area modulation control switches 522 are controlled by the area modulation control interconnect 520. When an area modulation control switch 522 is in an OFF state, a write-enabling voltage, when applied, can only reach the write-enabling switch 510 of the first sub-pixel 502a of the pixels 501 in a corresponding row. As such, only the first sub-pixel 502a is responsive to the data signal carried by the data interconnect 508. Thus, light is modulated by the first sub-pixel 502a and not the second sub-pixel 502b. Conversely, when the area modulation control switch 522 is in an ON state, a write-enabling voltage can reach the write-enabling switch 510 of both sub-pixels 502a and 502b of the pixels 501 in the row corresponding to the area modulation control switch 522. As a result, both the first sub-pixels 502a and the second sub-pixels 502b of the pixels 501 in the row are responsive to the data signal carried by the data interconnects 508 such that light may be modulated by both the first sub-pixels 502a and the second sub-pixels 502b.

In this way, each pixel can assume three different states, namely, a closed state in which both sub-pixels 502a and 502b block light, a partially open state in which light is transmitted through only the first sub-pixel 502a and a fully open state in which light is transmitted through both the sub-pixels 502a and 502b. However, as both sub-pixels respond to the same data voltage from a single data source, only two of the three states are possible in any given subframe. That is, when the area modulation control switch 522 is ON, the pixel 501a can either be in an OFF state in which both sub-pixels 502a and 502b are in a non-transmissive (i.e., light blocking) state, or in an ON state in which both the sub-pixels 502a and 502b are in a transmissive state. When the area modulation control switch 522 is OFF, the pixel 501a can either be in an OFF state in which both sub-pixels 502a and 502b are in non-transmissive state, or in an ON state in which only the first sub-pixel 502a is in a transmissive state.

The control matrix 500 depicted in FIG. 5 utilizes a single area modulation control switch 522 per row. The area modulation control switches 522 are controlled by a common area modulation control interconnect 520. As shown in FIG. 5, each of the area modulation control switches 522 corresponds to a full row of pixels 501. The control matrix 500 is configured such that the state of the area modulation control switch 522 for a row controls whether the second sub-pixels 502b of the pixels 501 in that row respond to the data voltage. In such implementations, the first sub-pixels 502a are always available to modulate light, while the second sub-pixels 502b are made available to modulate light only when the area modulation control switch 522 is in the ON state.

As described above, by selecting the number of sub-pixels in each pixel that respond to data in each subframe, the display is able to adjust the weight of each subframe without altering the duration for which the subframe is illuminated or the intensity at which it is illuminated. Table 1 is an example subframe weighting scheme that can be implemented using the switch architecture described above in relation to FIG. 5.

TABLE 1

| Bit No. | 1 | 2 | 3 | 4 | 5 | 6 | 7 | 8 |
|---|---|---|---|---|---|---|---|---|
| Total | 1 | 2 | 4 | 8 | 16 | 32 | 64 | 128 |
| Subframe | | | | | | | | |
| weight | | | | | | | | |
| Temporal | 1 | 1 | 4 | 4 | 16 | 16 | 64 | 64 |
| Subframe | | | | | | | | |
| weight | | | | | | | | |
| Switch | 0 | 1 | 0 | 1 | 0 | 1 | 0 | 1 |

Table 1 includes four rows. The first row indicates a bit number corresponding to a particular subframe. The second row represents the weight associated with the given subframe. The third row indicates the temporal weights (i.e., the relative duration) associated with the subframe. The fourth row represents the state of the area modulation control switch 522 during each subframe, wherein a “0” indicates that the area modulation control switch 522 is in an OFF state and a “1” indicates that the area modulation control switch 522 is in an ON state. As shown, bit #2 has a temporal weight that is the same as the temporal weight (i.e., 1) of bit #1, bit #4 has a temporal weight that is the same as the temporal weight (i.e., 4) of bit #3, bit #6 has a temporal weight that is the same as the temporal weight (i.e., 16) of bit #5, bit #8 has a temporal weight that is the same as the temporal weight (i.e., 64) of bit #7.

Although each even bit (bit #2, 4, 6, 8) has the same temporal weight as its preceding odd bit (for example, bit #1, 3, 5, 7), the overall weight associated with each of the even bits is twice the overall weight associated with its preceding equal duration odd bit. This is because the area modulation control switch 522 is in an ON state during each even bit. When the area modulation control switch 522 is the ON state, both sub-pixels 502a and 502b of the pixel 501a are used to modulate light, thereby modulating twice the amount of light compared to when the switch is in an OFF state. In this way, the effective weight of the subframe is doubled. As a result, by utilizing both temporal and spatial modulation, the subframe durations of bit #s 2, 4, 6 and 8 are reduced by half when compared to implementations that utilize only temporal modulation.

In some implementations, to avoid the second sub-pixels 502b from entering indeterminate states during the subframes associated with bits #1, 3, 5, an 7, a drive scheme can be implemented that drives all sub-pixels 502a and 502b into their closed states at the beginning or the end of each subframe. In some implementations, the drive scheme can be implemented to drive all the sub-pixels 502a and 502b at the beginning of each of the bit #s 1, 3, 5 and 7 or at the end of each of the bit #s 2, 4, 6 and 8. In some implementations, a global circuit can be utilized to implement such a drive scheme. The global shutter-closing circuit may be configured such that each of the sub-pixels is addressable directly by a common data interconnect. However, such a global circuit may take up valuable real estate as well as require additional circuitry, such as separate switches for each sub-pixel, thereby significantly increasing the complexity and costs of the circuit.

In some other implementations, instead of implementing a global shutter-closing circuit, the area modulation control switch 522 is configured to drive all the sub-pixels 502a and 502b into their closed state. To do this, the area modulation control switch 522 is switched ON and a data voltage corresponding to an OFF state is provided to each of the pixels. In this way, each of the sub-pixels is driven to a closed or OFF state. In some such implementations, additional subframes may be inserted before displaying subframes associated with bit #s 1, 3, 5 and 7 or after displaying the subframes associated with bit #s 2, 4, 6 and 8. The additional subframes may correspond to a closed state for all sub-pixels 502a and 502b so as to make sure that the second sub-pixels 502b are switched off when displaying bits #1, 3, 5 and 7. However, inserting additional subframes decreases the amount of time available for the original subframes, requiring the display light sources to be illuminated less efficiently at a greater intensity. Further, implementing a weighting scheme that requires the control switches 522 to alternate between an OFF state and an ON state after every subframe also increases power consumption.

In an effort to reduce power consumption caused by switching the control switches 522 between ON and OFF states, the order in which the subframes are displayed may be rearranged. In this way, subframes that correspond to an ON state of the control switches 522 are displayed after all the subframes that correspond to an OFF state of the control switches 522 are displayed, or visa versa. Further, each of the pixels may be initialized into OFF states before each frame.

As described above, by selecting the number of sub-pixels in each pixel that respond to data in each subframe, the display is able to adjust the weight of each subframe without altering the duration for which the subframe is illuminated or the intensity at which it is illuminated. Table 2 is an example subframe weighting scheme that also can be implemented using the switch architecture described above in relation to FIG. 5.

TABLE 2

| Bit No. | 1 | 2 | 3 | 4 | 5 | 6 | 7 | 8 |
|---|---|---|---|---|---|---|---|---|
| Total | 1 | 4 | 16 | 64 | 2 | 8 | 32 | 128 |
| Subframe | | | | | | | | |
| weight | | | | | | | | |
| Temporal | 1 | 4 | 16 | 64 | 1 | 4 | 16 | 64 |
| Subframe | | | | | | | | |
| weight | | | | | | | | |
| Switch | 0 | 0 | 0 | 0 | 1 | 1 | 1 | 1 |

Table 2 includes four rows. The first row indicates a bit number corresponding to a particular subframe. The second row represents the weight associated with the given subframe. The third row indicates the temporal weights (i.e., the relative duration) associated with the subframe. The fourth row represents the state of the area modulation control switch 522 during each subframe, wherein a “0” indicates that the area modulation control switch 522 is in an OFF state and a “1” indicates that the area modulation control switch 522 is in an ON state. As shown, bit #5 has a temporal weight that is the same as the temporal weight (i.e., 1) of bit #1, bit #6 has a temporal weight that is the same as the temporal weight (i.e., 4) of bit #2, bit #7 has a temporal weight that is the same as the temporal weight (i.e., 16) of bit #3, bit #8 has a temporal weight that is the same as the temporal weight (i.e., 64) of bit #4.

Although one of the last four bits (bit #5, 6, 7, 8) has the same temporal weight as a corresponding bit of the first four bits (for example, bit #1, 2, 3, 4), the overall weight associated with each of the last four bits is twice the overall weight associated with the first four bits. This is because the area modulation control switch 522 is in an ON state during the last four bits. When the area modulation control switch 522 is the ON state, both sub-pixels 502a and 502b of the pixel 501a are used to modulate light, thereby modulating twice the amount of light compared to when the switch is in an OFF state. In this way, the effective weight of the subframe is doubled. As a result, by utilizing both temporal and spatial modulation, the subframe durations of bit #s 5, 6, 7 and 8 are reduced by half when compared to implementations that utilize only temporal modulation. In this way, the same number of subframes can be displayed in a shorter amount of time than implementations that utilize pure temporal modulation. As a result, utilizing both temporal and spatial modulation can result in increasing the frame rate without reducing the number of subframes to be displayed. The increased frame rate can improve image quality. In particular, the increased frame rate can reduce the formation of image artifacts, such as image artifacts caused by color breakup and flicker.

In some implementations, an extra subframe is added to the beginning of each image frame or to the end of each image frame. The subframe is configured to cause each of the sub-pixels of the pixels to be driven to a closed state. In some such implementations, the extra subframe is displayed after the last subframe of the image frame is displayed. While all the area modulation control switches are switched ON, a data voltage corresponding to an OFF state is provided to each of the sub-pixels of the pixels. This allows each of the sub-pixels to be driven to a closed state, where they will remain until each of the sub-pixels are addressed again. This can prevent the sub-pixels from assuming an indeterminate or relaxed state, which may result in the leakage of light through such sub-pixels. In some other implementations, a global shutter-close circuit can be utilized to drive each of the sub-pixels to a closed or OFF state. The global shutter-closing circuit may be configured such that each of the sub-pixels is addressable directly by a common data interconnect. However, as described above, such a global circuit may take up valuable real estate as well as require additional circuitry, such as separate switches for each sub-pixel, thereby significantly increasing the complexity and costs of the circuit.

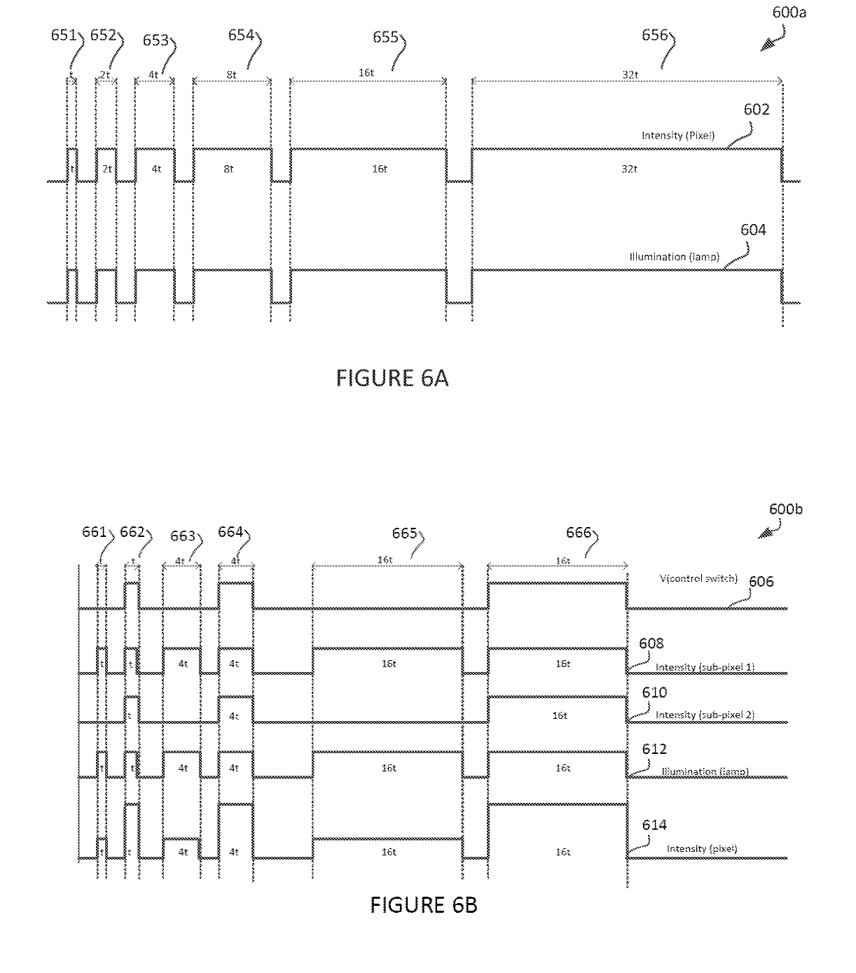

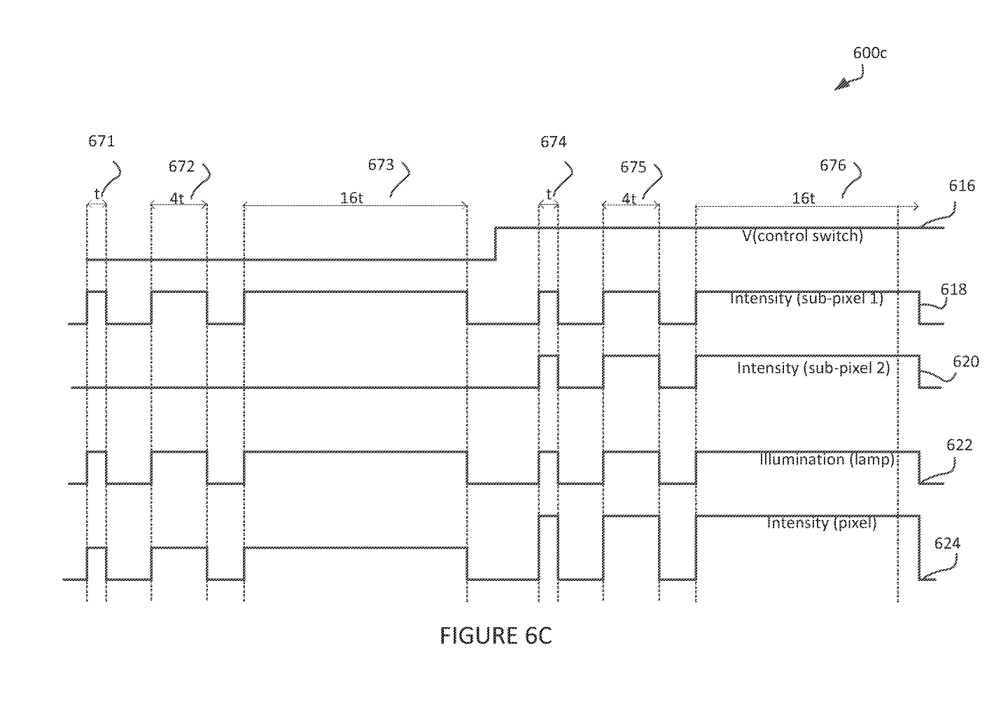

FIG. 6A shows an example timing diagram 600a of pixel intensity and lamp illumination. The timing diagram 600a corresponds to a display apparatus that employs temporal, but not spatial, subframe weighting. The timing diagram 600a is divided into regions corresponding to subframe durations of each bit of a 6-bit gray scale weighting scheme. The first region 651 corresponds to a first bit and has a subframe duration of t, the second region 652 corresponds to a second bit and has a subframe duration of 2 t, the third region 653 corresponds to a third bit and has a subframe duration of 4 t, the fourth region 654 corresponds to a fourth bit and has a subframe duration of 8 t, the fifth region 655 corresponds to a fifth bit and has a subframe duration of 16 t and the sixth region 656 corresponds to a sixth bit and has a subframe duration of 32 t.

The timing diagram 600a also includes timing graphs 602 and 604. The timing graph 602 corresponds to an intensity of a pixel. The timing graph 604 corresponds to the illumination of a light source. In accordance with a binary gray scale weighting scheme, each subframe has a weight that is twice the weight of a preceding subframe. Given that the subframe weighting scheme described in relation to FIG. 6A relies solely on subframe duration to set each subframe's weight, the subframe duration corresponding to the second bit of the gray scale weighting scheme is twice as long as the subframe duration corresponding to the first bit of the gray scale weighting scheme and the subframe duration corresponding to the third bit of the gray scale weighting scheme is twice as long as the subframe duration corresponding to the second bit of the gray scale weighting scheme, and so on. In this way, the total duration for displaying the subframes in a 6-bit binary gray scale weighting scheme is equal to t+2 t+4 t+8 t+16 t+32 t=63 t.

FIG. 6B shows an example timing diagram 600b of sub-pixel and pixel intensities and lamp illumination with the use of an area modulation control switch. The timing diagram 600b is divided into regions corresponding to subframe durations of each bit of a 6-bit gray scale weighting scheme. The first region 661 corresponds to a first bit and has a subframe duration of t, the second region 662 corresponds to a second bit and also has a subframe duration of t, the third region 663 corresponds to a third bit and has a subframe duration of 4 t, the fourth region 664 corresponds to a fourth bit and also has a subframe duration of 4 t, the fifth region 665 corresponds to a fifth bit and has a subframe duration of 16 t and the sixth region 666 corresponds to a sixth bit and also has a subframe duration of 16 t.

The timing diagram 600b corresponds to the use of a control matrix, such as the control matrix 500 depicted in FIG. 5, configured to implement a gray scale process that utilizes both temporal modulation and spatial modulation for implementing different weights of subframes. Referring to FIGS. 5 and 6, the timing diagram 600b includes timing graphs 606, 608, 610, 612 and 614. The timing graph 606 corresponds to a control voltage applied to the area modulation control switch 522 of the control matrix 500. When a high control voltage is applied to the area modulation control switch 522, the area modulation control switch 522 is in the ON state, which causes a data voltage to be applied to both the first sub-pixels 502a and the second sub-pixels 502b of a row of pixels 501. Conversely, when a low control voltage is applied to the area modulation control switch 522, the area modulation control switch 522 is in the OFF state, which causes a data voltage to be applied only to the first sub-pixels 502a of the row of pixels 501.

The timing graph 608 corresponds to an intensity of light transmitted through the first sub-pixel 502a. The timing graph 610 corresponds to an intensity of light being transmitted through the second sub-pixel 502b. When the area modulation control switch is in the OFF state as shown in regions 661, 663 and 665 of the timing graph 606, regardless of the data voltage provided to the second sub-pixel, there is no light transmitting through the second sub-pixel 502b, as depicted in the regions 661, 663 and 665 of timing graph 610. Conversely, when the area modulation control switch is in the ON state, as shown in regions 662, 664 and 666 of the timing graph 606, light can be transmitted through both the first sub-pixel 502a, as depicted in the regions 662, 664 and 666 of the timing graph 608 and the second sub-pixel 502b as depicted in the regions 662, 664 and 666 of the timing graph 610. The timing graphs 608-614 assume that the data voltages provided for each subframe indicate a light transmissive state.

The timing graph 612 corresponds to the illumination level of a light source. The timing graph 614 corresponds to the total intensity of light transmitted through a pixel 501. As shown in the timing graph 614, the intensity of light transmitted through the pixel 501 corresponds to the sum of the light being transmitted by the first sub-pixel 502a and the second sub-pixel 502b. As such, the intensity of the light that potentially can be transmitted through the pixel 501a when the area modulation control switch 522 is in the ON state is twice the intensity of the light that can be transmitted through the pixel 501 when the area modulation control switch 522 is in the OFF state. This is because when the area modulation control switch 522 is in the OFF state, no light can be transmitted through the second sub-pixel 502b. By utilizing the control matrix 500 depicted in FIG. 5, the total duration for displaying the subframes of a 6-bit binary gray scale weighting scheme is equal to the sum of the durations of each of the regions 661-666, which corresponds to t+t+4 t+4 t+16 t+16 t=42 t. When compared to the total duration for displaying the subframes without the use of spatial modulation, a savings of approximately 33% (21 t/63 t) can be realized. This time saving can be used to allow a display apparatus to increase the number of subframes it displays for an image frame without increasing the amount of time allocated to the frame.

FIG. 6C shows an example timing diagram 600c of sub-pixel and pixel intensities and lamp illumination with the use of an area modulation control switch. The timing diagram 600c corresponds to Table 2. The timing diagram 600c is divided into regions corresponding to subframe durations of each bit of a 6-bit gray scale weighting scheme. The first region 671 corresponds to a first bit and has a subframe duration of t, the second region 672 corresponds to a second bit and also has a subframe duration of 4 t, the third region 673 corresponds to a third bit and has a subframe duration of 16 t, the fourth region 674 corresponds to a fourth bit and also has a subframe duration of t, the fifth region 675 corresponds to a fifth bit and has a subframe duration of 4 t and the sixth region 676 corresponds to a sixth bit and also has a subframe duration of 16 t.

The timing diagram 600c corresponds to the use of a control matrix, such as the control matrix 500 depicted in FIG. 5, configured to implement a gray scale process that utilizes both temporal modulation and spatial modulation for implementing different weights of subframes. Referring to FIGS. 5 and 6C, the timing diagram 600c includes timing graphs 616, 618, 620, 622 and 624. The timing graph 616 corresponds to a control voltage applied to the area modulation control switch 522 of the control matrix 500. When a high control voltage is applied to the area modulation control switch 522, the area modulation control switch 522 is in the ON state, which causes a data voltage to be applied to both the first sub-pixels 502a and the second sub-pixels 502b of a row of pixels 501. Conversely, when a low control voltage is applied to the area modulation control switch 522, the area modulation control switch 522 is in the OFF state, which causes a data voltage to be applied only to the first sub-pixels 502a of the row of pixels 501.

The timing graph 618 corresponds to an intensity of light transmitted through the first sub-pixel 502a. The timing graph 620 corresponds to an intensity of light being transmitted through the second sub-pixel 502b. When the area modulation control switch is in the OFF state as shown in regions 671, 672 and 673 of the timing graph 616, regardless of the data voltage provided to the second sub-pixel, there is no light transmitting through the second sub-pixel 502b, as depicted in the regions 671, 672 and 673 of timing graph 620. Conversely, when the area modulation control switch is in the ON state, as shown in regions 674, 675 and 676 of the timing graph 616, light can be transmitted through both the first sub-pixel 502a, as depicted in the regions 674, 675 and 676 of the timing graph 618 and the second sub-pixel 502b as depicted in the regions 674, 675 and 676 of the timing graph 620. The timing graphs 618-624 assume that the data voltages provided for each subframe indicate a light transmissive state.

The timing graph 622 corresponds to the illumination level of a light source. The timing graph 624 corresponds to the total intensity of light transmitted through a pixel 501. As shown in the timing graph 624, the intensity of light transmitted through the pixel 501 corresponds to the sum of the light being transmitted by the first sub-pixel 502a and the second sub-pixel 502b. As such, the intensity of the light that potentially can be transmitted through the pixel 501a when the area modulation control switch 522 is in the ON state is twice the intensity of the light that can be transmitted through the pixel 501 when the area modulation control switch 522 is in the OFF state. This is because when the area modulation control switch 522 is in the OFF state, no light can be transmitted through the second sub-pixel 502b. By utilizing the control matrix 500 depicted in FIG. 5, the total duration for displaying the subframes of a 6-bit binary gray scale weighting scheme is equal to the sum of the durations of each of the regions 671-676, which corresponds to t+4 t+16 t+t+4 t+16 t=42 t. When compared to the total duration for displaying the subframes without the use of spatial modulation, a savings of approximately 33% (21 t/63 t) can be realized. This time saving can be used to allow a display apparatus to increase the number of subframes it displays for an image frame without increasing the amount of time allocated to the frame.

Although the subframe weighting scheme described in relation to FIGS. 6A-6C is a 6-bit binary gray scale weighting scheme, other types of weighting schemes, including binary and non-binary gray scale weighing schemes using any number of bits, also can be implemented using the combined area and time modulation display processes described herein.

In some implementations, the display elements of a particular pixel can have different sizes. For example, a pixel can include a first display element that is twice the size of a second display element. By having display elements of varying sizes, more complicated area modulation weighting schemes can be employed. Such weighting schemes can provide more flexibility and redundancy allowing for improved image quality or reduced power consumption, or both.

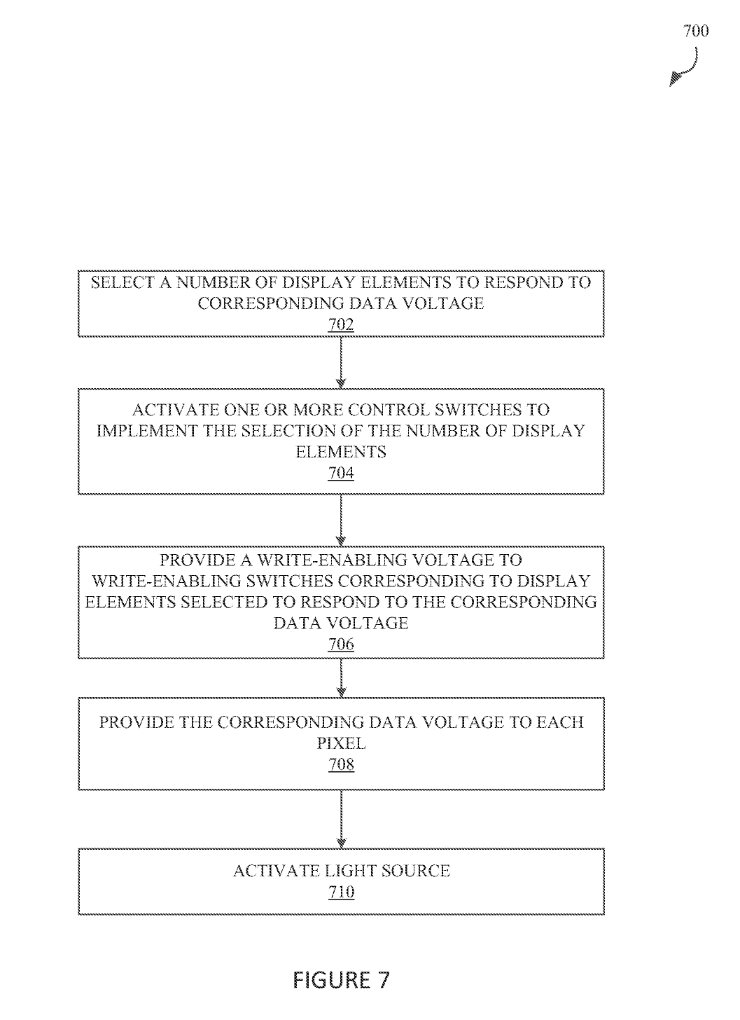

FIG. 7 shows a flow diagram of an example pixel actuation method. The pixel actuation method 700 may be employed, for example, to operate the control matrix 500 of FIG. 5. The pixel actuation method 700 proceeds by selecting a number of display elements that will respond to a corresponding data voltage (block 702). Next, one or more area modulation control switches are activated to implement the selection of the number of display elements (block 704). A write-enabling voltage is then provided to write-enabling switches corresponding to the selected display elements (block 706). Data voltages are then provided to each pixel (block 708). The method 700 ends with activating a light source (block 710).

As set forth above, the pixel actuation method 700 begins with the selection of a number of display elements to respond to a corresponding data voltage (block 702). The selection may be made, by a display controller, such as the controller 134 depicted in FIG. 1B, coupled to the control matrix. The controller may obtain the number of display elements to select from a look-up table associating each subframe with the appropriate number of display elements that are to be used in displaying that sub frame.

In some implementations, the number of display elements to be selected can depend on the weight of the subframe to be displayed. In some implementations, such as in a six bit binary gray scale weighting scheme, the first, second and third subframes (in terms of significance or weight) are displayed using one display element per pixel, while the fourth, fifth and sixth subframes (in terms of significance or weight) are displayed using two display elements per pixel. As such, to display the first, second and third subframes, one display element is selected to respond to a corresponding data voltage. Conversely, to display the fourth, fifth and sixth subframes, two display elements per pixel are selected to respond to a corresponding data voltage. In some implementations, the subframes that are displayed using one display element per pixel are displayed before the subframes that are displayed using two display elements per pixel. In some implementations, the subframes need not be displayed in a particular order, such as with increasing weights. Rather, subframes may be displayed in any order so long as they are illuminated for the appropriate amount of time, with the appropriate color and intensity and with the appropriate area modulation control switch setting.

Upon selecting a number of display elements to respond to a corresponding data voltage, one or more area modulation control switches are activated to implement the selection of the number of display elements (block 704). In some implementations, the area modulation control switches are controlled by an area modulation control interconnect coupled to a driver, which is in turn controlled by the controller. To activate an area modulation control switch, the driver applies a control voltage to the area modulation control interconnect.

Upon activating one or more of the area modulation control switches to implement the selection of the number of display elements, the area modulation control switches allow for a write-enabling voltage to be provided to the appropriate write-enabling switches corresponding to the display elements selected to respond to the corresponding data voltage (block 706). The write-enabling switches that receive the write-enabling voltage are activated, rendering such sub-pixels to assume a write-enabled state. The write-enabling voltage can be provided to the write-enabling switches of each sub-pixel via a corresponding primary or secondary scan-line interconnect.

Upon providing a write-enabling voltage to the write-enabling switches corresponding to the selected display elements, the corresponding data voltage is provided to each pixel (block 706). In some implementations, the corresponding data voltage is provided to each of the sub-pixels of the pixel. Those sub-pixels that assume the write-enabled state allow corresponding data store capacitors to store data voltages carried by corresponding data interconnects. In this way, the selected display elements can assume a state corresponding to the data voltage upon updating the display elements.

Upon the display elements assuming the states indicated by the data voltages, a light source is activated (block 710). Activating a light source displays the sub frame.

In some implementations, prior to displaying a subframe, the pixels of the display are initialized into an OFF state. In this way, each of the display elements of the pixel is driven to a closed state such that light does not pass through the display elements. In some implementations, prior to displaying any of the subframes of an image, the order in which the subframes are displayed is arranged. In some such implementations, the subframes are arranged such that all subframes that only use one display element are displayed first and then subframes that use two display elements are displayed next, and then subframes that use three display elements are displayed. Subframes may also be arranged to satisfy other concerns. In some implementations, subframes may be arranged to reduce the likelihood of the formation of image artifacts.

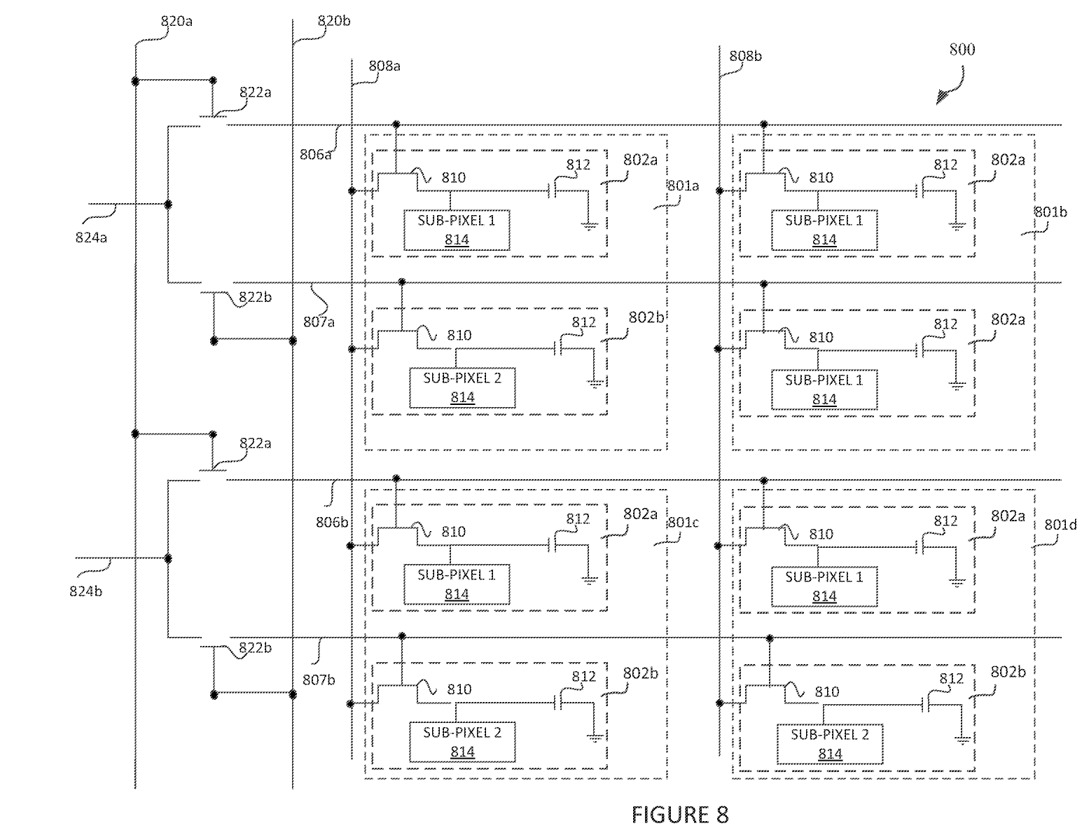

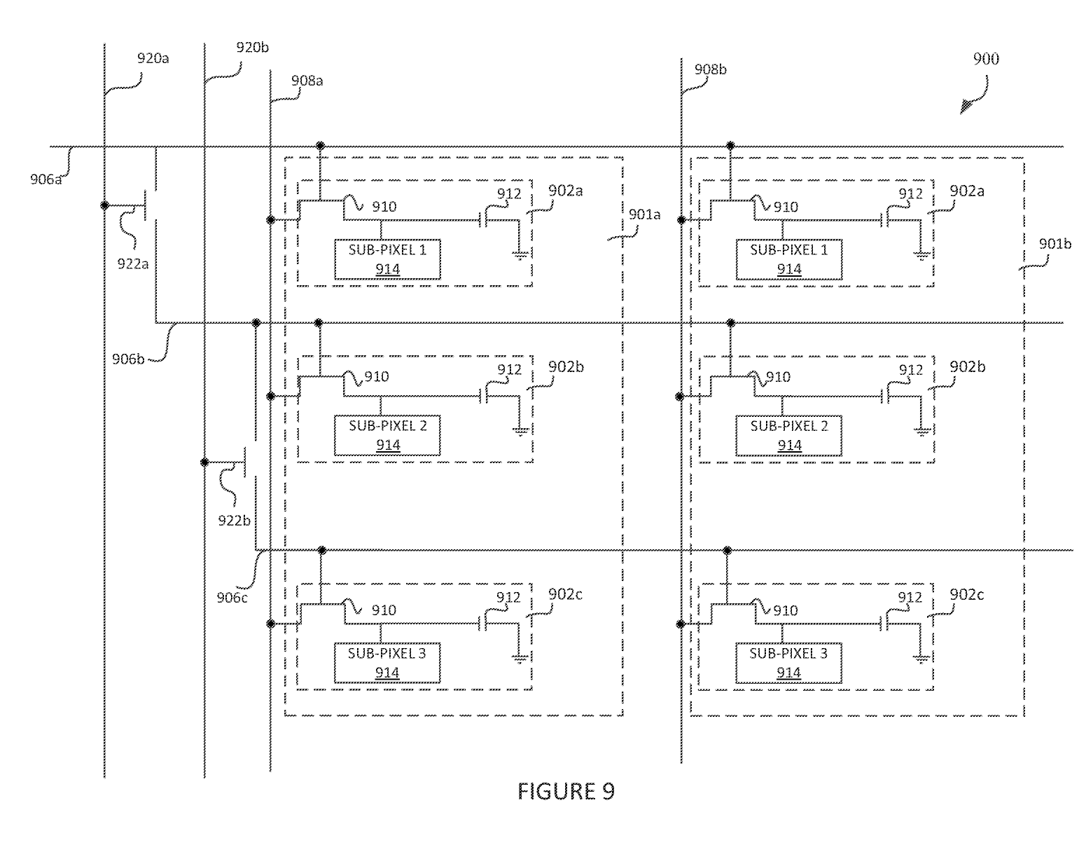

FIGS. 8 and 9 show a portion of example control matrices. Specifically, FIG. 8 shows a portion of another example control matrix 800. Similar to the control matrix 500 depicted in FIG. 5, the control matrix 800 allows for the implementation of subframe weights utilizing both temporal and spatial modulation. However, in contrast to the control matrix 500, the control matrix 800 provides the flexibility to allow either a first sub-pixel or a second sub-pixel of a given pixel to respond to the data voltage during those subframes in which only one of the sub-pixels is responsive to the data voltage. This is achieved by including area modulation control logic that includes two separate area modulation control switches and corresponding area modulation control interconnects such that the utilization of the sub-pixels of the various rows can be individually controlled. In this way, the utilization of the sub-pixels can be evenly balanced. That is, each of the sub-pixels can be utilized equally since each of the sub-pixels are controlled independent from other sub-pixels. For example, for subframes in which only one sub-pixel is selected to respond to a data voltage, the control matrix may alternate between the first sub-pixel responding to the data voltage and the second sub-pixel responding to the data voltage each row, each column, in a checkerboard fashion, or in any other patterned or random fashion. This is in contrast with the control matrix 500 depicted in FIG. 5, in which the utilization of the second sub-pixel 502b also requires the first sub-pixel 502a to be utilized.

The control matrix 800 includes an array of pixels 801a-801d (generally “pixels 801”). The array of pixels 801a-801d are arranged in rows and columns. A first row of pixels 801 includes pixel 801a and pixel 801b and a second row of pixels 801 includes pixel 801c and pixel 801d. Similarly, a first column of pixels includes pixel 801a and pixel 801c and a second column of pixels includes pixel 801b and pixel 801d. The control matrix 800 also includes a plurality of data interconnects 808a and 808b (generally “data interconnects 808”), each corresponding to a respective column of pixels.

The control matrix 800, for each row of pixels 801, includes a corresponding upper scan-line interconnect 806. For example, the control matrix 800 includes a first upper scan-line interconnect 806a corresponding to the first row of pixels 801 and a second upper scan-line interconnect 806b corresponding to the second row of pixels 801. Similarly, the control matrix 800, for each row of pixels 801, includes a corresponding lower scan-line interconnect 807. For example, the control matrix 800 includes a first lower scan-line interconnect 807a corresponding to the first row of pixels 801, and a second lower scan-line interconnect 807b corresponding to the second row of pixels 801. Further, the control matrix 800 also includes, for each row of pixels 801, a corresponding source scan-line interconnect 824 coupled to a scan line driver. For example, the control matrix 800 includes a first source scan-line interconnect 824a corresponding to the first row of pixels and a second source scan-line interconnect 824b corresponding to the second row of pixels.

The control matrix 800 includes, for each row of pixels 801, a corresponding upper area modulation control switch 822a. For example, the control matrix 800 includes a first upper area modulation control switch 822a corresponding to the first upper scan-line interconnect 806a and a second upper area modulation control switch 822b corresponding to the second upper scan-line interconnect 806b. Similarly, the control matrix 800 also includes, for each row of pixels 801, a corresponding lower area modulation control switch 822b. For example, the control matrix 800 includes a first lower area modulation control switch 822b corresponding to the first lower scan-line interconnect 807a and a second lower area modulation control switch 822b corresponding to the second lower scan-line interconnect 807b.

In some implementations, each of the upper area modulation control switches 822a is configured to control a write-enabling voltage applied to a corresponding upper scan-line interconnect 806. Each of the upper area modulation control switches 822a is configured to be controlled by a common upper area modulation control interconnect 820a such that when the upper area modulation control interconnect 820a applies a high control voltage to the upper area modulation control switches 822a, the upper area modulation control switches 822a are switched to an ON state. In this way, the write-enabling voltage applied at a corresponding source scan-line interconnect 824 can be provided to a corresponding upper scan-line interconnect 806.

Similarly, in some implementations, each of the lower area modulation control switches 822b is configured to control a write-enabling voltage applied to a corresponding lower scan-line interconnect 807. Each of the lower area modulation control switches 822b is configured to be controlled by a common lower area modulation control interconnect 820b such that when the lower area modulation control interconnect 820b applies a high control voltage to the lower area modulation control switches 822b, the lower area modulation control switches 822b are switched to an ON state. In this way, the write-enabling voltage applied at a corresponding source scan-line interconnect 824 can be provided to a corresponding lower scan-line interconnect 807.

Similar to the control matrix 500 depicted in FIG. 5, each pixel 801 includes an upper sub-pixel 802a and a lower sub-pixel 802b (generally “sub-pixel 802”). Each sub-pixel 802 includes a write-enabling switch 810, a data store capacitor 812 and a display element 814. The display element 814 includes a light modulator. The light modulator includes a light blocking element, such as a shutter. In some other implementations, each of the display elements 814 corresponding to a pixel 801 may be configured to modulate an equal amount of light. As described above, this can be achieved, for example, by having display elements that include equally sized light modulating components. In some other implementations, however, the light modulating components of the display elements 814 may be unequal in size. In such implementations, the amount of light modulated by each of the display elements 814 may be different.

The write-enabling switch 810 can be a transistor having a drain terminal connected to a data interconnect 808, a gate terminal connected to a corresponding scan-line interconnect and a source terminal connected to the data store capacitor 812 and the display element 814 of the sub-pixel 802. If the write-enabling switch 810 is an NMOS transistor, when a write-enabling voltage greater than a threshold voltage of the transistor is applied to the gate terminal, the data voltage applied to the data interconnect 808 is stored at the data store capacitor 812. In this way, the sub-pixels 802 can be loaded with a data voltage.

The states of the upper area modulation control switches 822a control whether the upper sub-pixels 802a in each row of pixels respond to the data voltages provided via the data interconnects 808. The states of the upper area modulation control switches 822a are controlled by corresponding upper area modulation control interconnects 820a. Similarly, the states of the lower area modulation control switches 822b are controlled by corresponding lower area modulation control interconnects 820b. The states of the lower area modulation control switches 822b control whether the lower sub-pixels 802b in each row of pixels responds to the data voltages applied via the data interconnects 808.

For each pixel 801, when an upper area modulation control switch 822a is in an ON state, the first sub-pixel 802a of a pixel 801 is responsive to the data signal on the data interconnect 808 corresponding to the column of pixels in which the pixel 801 is located such that the upper sub-pixel 802a can modulate light. Similarly, when a lower area modulation control switch 822b is in an ON state, the lower sub-pixel 802b of the pixel 801 is responsive to the data signal on the data interconnect 808. When both the upper area modulation control switch 822a and the lower area modulation control switch 822b are in an ON state, both the upper sub-pixel 802a and the lower sub-pixel 802b of the pixel 801 are responsive to the data signal on the data interconnect 808 such that light may be modulated by both the upper sub-pixel 802a and the lower sub-pixel 802b.

In this configuration, during any given subframe, each pixel 801 can assume one of four different physical states, namely, a closed state in which both sub-pixels 802a and 802b block light, a first partially open state in which light is transmitted through only the upper sub-pixel 802a, a second partially open state in which light is transmitted through only the lower sub-pixel 802b and a fully open state in which light is transmitted through both the sub-pixels 802a and 802b. However, in any given subframe, the pixel 801 still can assume only one of two logical states responsive to the data voltage. If the data voltage corresponds to an OFF state, none of the sub-pixels 802 of the pixel 801 allow any light to be transmitted, whereas if the data voltage corresponds to an ON state, the number of sub-pixels of the pixel that allow light to be transmitted depends on the states of the upper and lower area modulation control switches. The pixel 801 can assume a first light-transmissive state in which only one sub-pixel (either sub-pixel 802a or sub-pixel 802b) is transmitting light or a second light-transmissive state in which both the sub-pixels 802a and 802b are transmitting light.

FIG. 9 shows an example portion of a control matrix 900 that includes two area modulation control interconnects and two area modulation control switches. In contrast to the control matrix 500 depicted in FIG. 5 and the control matrix 800 depicted in FIG. 8, this configuration is suitable for use with pixels that include three display elements that are controlled by the same data source, such as a data interconnect.

The control matrix 900 includes an array of pixels 901, including pixels 901a and 901b. The array of pixels 901 are arranged in rows and columns. The control matrix 900 also includes a plurality of data interconnects 908a and 908b (generally “data interconnects 908”), each corresponding to a respective column of pixels 901. The control matrix 900, for each row of pixels 901, includes a first scan-line interconnect 906a, a second scan-line interconnect 906b, and a third scan-line interconnect 906c (generally “scan-line interconnects 906”).

In addition, the control matrix 900 includes, for each row of pixels 901, a corresponding primary area modulation control switch 922a configured to control a write-enabling voltage applied to a corresponding second scan-line interconnect 906b. The control matrix 900 also includes, for each row of pixels 901, a corresponding secondary area modulation control switch 922b configured to control the application of a write-enabling voltage to a corresponding third scan-line interconnect 906c.

The primary area modulation control switches 922a are configured to be controlled by a common first area modulation control interconnect 920a. In some implementations, each of the first area modulation control switches 922a is configured to control the write-enabling voltage applied to a corresponding second scan-line interconnect 907 of a given row of pixels 901.

When the first area modulation control interconnect 920a applies a high control voltage to the primary area modulation control switches 922a, the primary area modulation control switches 922a are switched to an ON state. In this way, a write-enabling voltage applied to a first scan-line interconnect 906a is provided to a corresponding second scan-line interconnect 906b.

Similarly, each secondary area modulation control switch 922b is configured to control a write-enabling voltage applied to a corresponding third scan-line interconnect 906c. Each secondary area modulation control switch 922b is configured to control the application of a write-enabling voltage to a corresponding third scan-line interconnect 906c.

When the second area modulation control interconnect 920b applies a high control voltage to the secondary area modulation control switches 922b, the secondary area modulation control switches 922b are switched to an ON state. In this way, a write-enabling voltage applied at a second scan-line interconnect 906b is provided to a corresponding third scan-line interconnect 906c. In some implementations, the area modulation control interconnects 920a and 920b are common in that they provide control voltages to area modulation control switches that belong to more than row of pixels 901.

Unlike the control matrix 500 depicted in FIG. 5 and the control matrix 800 depicted in FIG. 8, each pixel 901 includes a first sub-pixel 902a, a second sub-pixel 902b and a third sub-pixel 902c (generally sub-pixel 902). Each sub-pixel 902 includes a write-enabling switch 910, a data store capacitor 912 and a display element 914. Each display element 914 includes a light modulator. In some implementations, the light modulator includes a light blocking element, such as a shutter. In some other implementations, each of the display elements 914 in a pixel 901 may be configured to modulate an equal amount of light. This can be achieved, for example, by having display elements 914 that include equally sized light modulating components. In some other implementations, however, the light modulating components of the display elements 914 may be unequal in size. In such implementations, the amount of light modulated by each of the display elements 914 may be different. In some binary weighting schemes, the three sub-pixels can have an effective area ratio of 1:1:2. That is, the area of one of the sub-pixels through which light is modulated is twice as large as the area of the other two sub-pixels through which light is modulated. In this way, a binary weighting scheme having weights of “1”, “2” and “4” can be implemented by selecting an appropriate number of sub-pixels to respond to the corresponding data voltage provided by the data interconnect. For example, to implement a weight of “1”, only one of the sub-pixels having a smaller area responds to the corresponding data voltage. To implement a weight of “2”, both the sub-pixels having smaller areas respond to the corresponding voltage. To implement a weight of “4”, all three sub-pixels, including the sub-pixel that has an area that is twice the area of the other two sub-pixels, are responsive to the corresponding data voltage provided by the data interconnect. Additional details regarding this implementation are provided below.

The write-enabling switch 910 of a sub-pixel 902 can be a transistor having a drain terminal connected to a corresponding data interconnect 908, a gate terminal connected to a corresponding scan-line interconnect, such as a first, second or third scan-line interconnect 906a, 906b, or 906c, and a source terminal connected to the data store capacitor 912 and the display element 914 of the sub-pixel 902. If the write-enabling switch 910 is an NMOS transistor, when a write-enabling voltage greater than a threshold voltage of the transistor is applied to the gate terminal, the data voltage applied to the data interconnect 908 is stored at the data store capacitor 912. In this way, the sub-pixels 902 can be loaded with a data voltage.

The state of the primary area modulation control switch 922a controls whether the second sub-pixels 902b in a row of pixels respond to the data voltages provided via the data interconnects 908. The states of the primary area modulation control switches 922a are controlled by the first area modulation control interconnect 920a. When the primary area modulation control switch 922a is in an OFF state, a write-enabling voltage, when applied, can only reach the first sub-pixels 902a of the pixels 901 in a corresponding row. As such, only the first sub-pixels 902a are responsive to data signals carried by the data interconnects 908. Conversely, when the primary area modulation control switch 922a is in an ON state, a write-enabling voltage, when applied, can reach the first sub-pixels 902a and the second sub-pixels 902b of the pixels 901 in a corresponding row. As such, at least the first and second sub-pixels 902a and 902b are responsive to the data signal carried by the data interconnect 908.

Similarly, the state of the secondary area modulation control switch 922b controls whether the third sub-pixels 902c in the same row of pixels respond to the data voltages applied via the same data interconnects 908. The states of the secondary area modulation control switches 922b are controlled by the second area modulation control interconnect 920b. When a secondary area modulation control switch 922b for a row is in an OFF state, a write-enabling voltage, when applied to the secondary area modulation control switch 922b, can not reach the third sub-pixels 902c of the pixels 901 in the corresponding row. Conversely, when the secondary area modulation control switch 922b for a row is in an ON state, a write-enabling voltage, when applied to the secondary area modulation control switch 922b, can reach the second sub-pixels 902b and the third sub-pixels 902c of the pixels 901 in a corresponding row. In this way, the third sub-pixels 902c are responsive to the data signals carried by the data interconnects 908.

In some implementations, the third sub-pixels 902c may respond to the data voltage applied via the data interconnects 908 when both the primary area modulation control switch 922a and the secondary area modulation control switch 922b are in the ON state. In such implementations, if the primary area modulation control switch 922a is in the OFF state, the third sub-pixels 902c can not respond to the data voltage applied via the data interconnect 908a, regardless of the state of the secondary area modulation control switch 922b since no write-enabling voltage is applied to the second scan-line interconnect 906b.

In this way, each pixel 901 can assume four different physical states, namely, a closed state in which all three sub-pixels 902a-902c block light, a first partially open state in which light is transmitted through only the first sub-pixel 902a, a second partially open state in which light is transmitted through only the first sub-pixel 902a and the second sub-pixel 902b, and a fully open state in which light is transmitted through all the sub-pixels 902a-902c. However, as all three sub-pixels 902a-902c respond to the same data voltage from a single data source, only two of the four states are possible in any given subframe. That is, when the primary area modulation control switch 922a is ON, the pixel 901a can either be in an OFF state in which all three sub-pixels 902a-902c are in a non-transmissive (i.e., light blocking) state, or in an ON state in which at least the first sub-pixel 902a and the second sub-pixel 902b are in a transmissive state. When the primary area modulation control switch 922a is OFF, the pixel 901a can either be in an OFF state in which all the sub-pixels 902a-902c are in non-transmissive state, or in an ON state in which only the first sub-pixel 902a is in a transmissive state. When the secondary area modulation control switch 922b is ON, the pixel 901a can either be in an OFF state in which all three sub-pixels 902a-902c are in a non-transmissive state, or in an ON state in which all three sub-pixels 902a-902c are in a transmissive state provided the primary area modulation control switch 922a is also ON. If the primary area modulation control switch 922a is in an OFF state, regardless of the state of the secondary area modulation control switch 922b, the sub-pixels 902b and 902c will be in a non-transmissive state. Further, if the primary area modulation control switch 922a is in the ON state and the secondary area modulation control switch 922b is in the OFF state, only the first sub-pixel 902b and the second sub-pixel 902c will be in a transmissive state, provided the pixel 901a is in the ON state.

As described above, in some implementations that implement a binary weighting scheme, the three sub-pixels can have an effective modulated area ratio of 1:1:2. Specifically, the first sub-pixel 902a and a second sub-pixel 902b can have effective areas (i.e., areas through which light can be modulated) that are half the effective area of the third sub-pixel 902c. To implement a weight of “1” for a subframe, both the primary area modulation control switch 922a and the secondary area modulation control switch 922b are OFF. In this way, only the first sub-pixel 902a is selected to respond to the corresponding data voltage. To implement a weight of “2”, the primary area modulation control switch 922a is switched ON while the secondary area modulation control switch 922b remains OFF. In this way, both the first sub-pixel 902a and the second sub-pixel 902b are selected to respond to the corresponding data voltage. To implement a weight of “4”, both the primary area modulation control switch 922a and the secondary area modulation control switch 922b are switched ON. In this way, all three of the first sub-pixel 902a, the second sub-pixel 902b and the third sub-pixel 902c are selected to respond to the corresponding data voltage. In this way, the total area through which light can be modulated is 4 times as large as the area through which light is modulated when implementing a weight of “1”.

In some implementations, each of the sub-pixels can operate in more than two distinct states. Assuming n to be the number of possible states in which the sub-pixels can operate, the ratio of the area through which light can be modulated by respective sub-pixels may be 1:(n−1). That is, one of the sub-pixels has an effective area that is (n−1) times as large as the effective area of the other sub-pixel. Consider, sub-pixels that can operate in three states, namely a closed state, a partially open state and a fully open state. When incorporating such sub-pixels in a display apparatus that includes two sub-pixels per pixel, the ratio of the area through which light can be modulated by the respective sub-pixels may be 1:2. That is, one of the sub-pixels has an effective area that is twice as large as the effective area of the other sub-pixel.

In some implementations, each pixel may include m number of elements. In a digital display apparatus that incorporates a binary weighting scheme, the display area ratio of the m display elements is 1, 1, 2, 4, 8 . . . 2^{(m-2)}. More generally, for a digital display apparatus that includes m number of display elements per pixel and incorporates an n-base weighting scheme, the display area ratio of the m display elements is 1, n−1, n²−n, n³−n², n⁴−n³, n⁵−n⁴, . . . n^{m-1}−n^{m-2}.

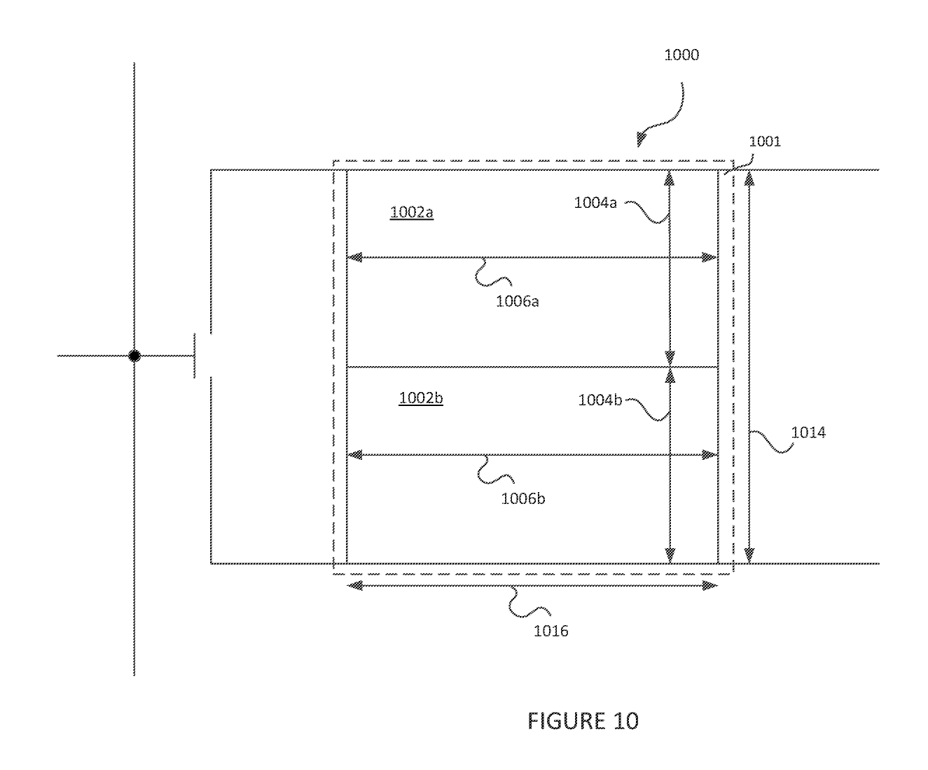

FIG. 10 shows an example pixel 1001 of a display apparatus. The pixel 1001 includes a first display element 1002a and a second display element 1002b. As described above, the display elements 1002a and 1002b may be light modulators or other types of display elements. As depicted in FIG. 10, the first display element 1002a has a width 1004a and a length 1006a. Similarly, the second display element 1002b has a width 1004b and a length 1006b. In some implementations, the aspect ratio of each of the display elements is 2:1, such that the length is twice as long as the width of each display element. When the two display elements are arranged such that the first display element 1002a is vertically adjacent to the second display element 1002b, the width 1014 of the pixel 1001 is equal to the sum of the widths 1004a and 1004b, while the length 1016 of the pixel 1001 is equal to the lengths 1006a and 1006b of each of the display elements 1002a and 1002b. As a result, the aspect ratio of the pixel 1001 is 1:1. In some implementations, the aspect ratio of each of the display elements is at least 2:1, such that the length is at least twice as long as the width of each display element. As a result, the aspect ratio of the pixel 1001 is about 1:1. Stated in another way, the effective area of the pixel 1001 can be generally square. In some implementations, the effective area of the sub-pixels of any given pixel can be of any shape, for example, square, rectangular, oval or triangular. In some such implementations, regardless of the shape of the sub-pixels, the ratio of the effective areas of the sub-pixels may be configured to implement one or more weighting schemes.

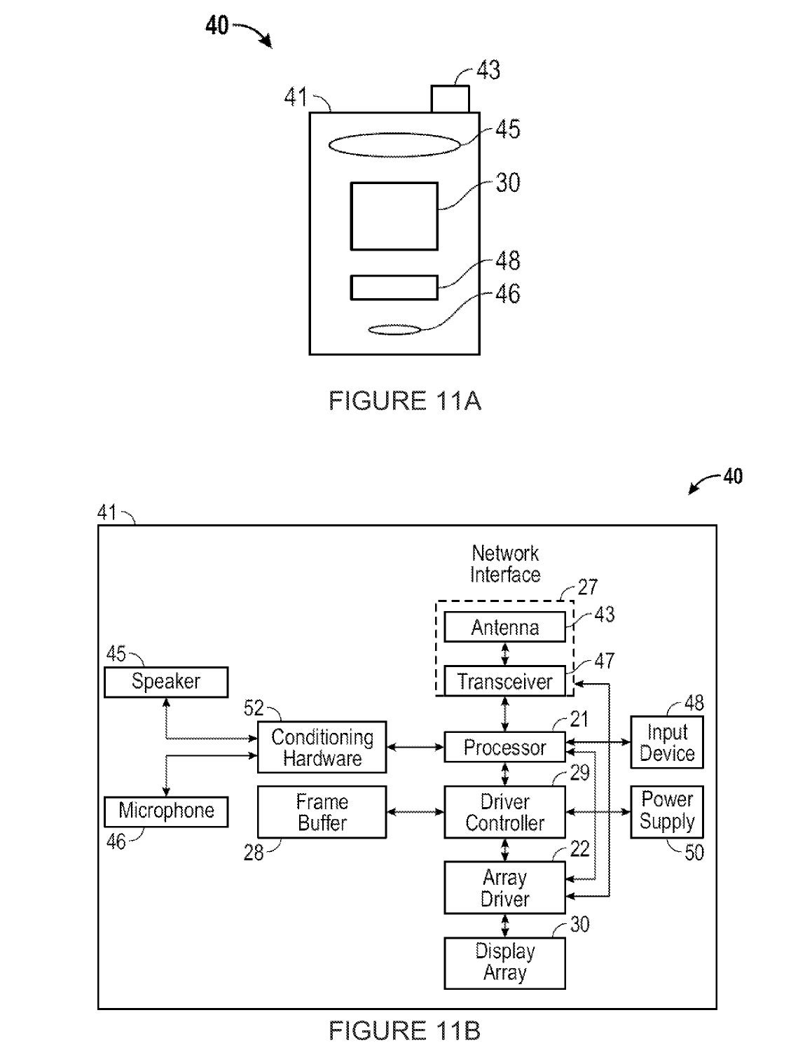

FIGS. 11A and 11B are system block diagrams illustrating a display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, electroluminescent (EL), organic light-emitting diode (OLED), super-twisted nematic liquid crystal display (STN LCD), or thin film transistor (TFT) LCD, or a non-flat-panel display, such as a cathode ray tube (CRT) or other tube device.

The components of the display device 40 are schematically illustrated in FIG. 11A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 11A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 801.11 standard, including IEEE 801.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22, and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as the controller 134 described above with respect to FIG. 1). Additionally, the array driver 22 can be a conventional driver or a bi-stable display driver. Moreover, the display array 30 can be a conventional display array or a bi-stable display array (such as a display including an array of display elements, such as light modulator array 320 depicted in FIG. 3B). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for displaying images, comprising:
a set of pixels, each pixel including at least two display elements configured to be controlled by a common data voltage; and
a control matrix including:
a single data interconnect configured to provide a data voltage for each pixel;
an area modulation control logic for selecting a number of display elements included in each pixel of the set of pixels to respond to the corresponding data voltage provided by the data interconnect; and
at least one area modulation control interconnect for controlling the area modulation control logic.

2. The apparatus of claim 1, wherein the area modulation control logic is configured to provide, for a first subframe, the corresponding data voltage to one of the at least two display elements and to provide, for a second subframe, the corresponding data voltage to both of the at least two display elements.

3. The apparatus of claim 1, wherein the area modulation control logic includes a first switch for selecting two display elements in each pixel of the set of pixels to respond to the corresponding data voltage provided by the data interconnect.

4. The apparatus of claim 1, wherein the area modulation control logic includes a first switch and a second switch for selecting three display elements in each pixel of the set of pixels to respond to the corresponding data voltage provided by the data interconnect.

5. The apparatus of claim 1, wherein the area modulation control logic includes a first switch for selecting a first display element in each of the set of pixels to respond to the corresponding data voltage provided by the data interconnect and a second switch for selecting a second display element in each pixel of the set of pixels to respond to the corresponding data voltage provided by the data interconnect.

6. The apparatus of claim 5, wherein the at least one area modulation control interconnect includes a first area modulation control interconnect for controlling the first switch and a second area modulation control interconnect for controlling the second switch.

7. The apparatus of claim 1, wherein the at least two display elements are configured to achieve, at a given time, one of a closed state and an open state, and wherein one of the at least two display elements modulates an area through which light is modulated that is two times as large as an area of an other of the at least two display elements through which light is modulated.

8. The apparatus of claim 1, wherein the at least two display elements are configured to achieve, at any given time, one of n possible states, and wherein one of the at least two display elements has an area through which light is modulated that is n−1 times as large as an area of an other of the at least two display elements through which light is modulated.

9. The apparatus of claim 1, wherein the at least two display elements include a first display element, a second display element and a third display element, each configured to achieve, at a given time, one of a closed state and a open state, and wherein the first display element has an area through which light is modulated that is two times as large as areas of the second display element and the third display element through which light is modulated.

10. The apparatus of claim 1, wherein the at least two display elements include m number of display elements and the apparatus is configured to implement an n-base weighting scheme, wherein a ratio of areas of the display elements takes a form of 1, n−1, n²−n, n³−n², n⁴−n³, n⁵−n⁴, . . . n^{m-1}−n^{m-2}.

11. The apparatus of claim 1, wherein the display elements include electromechanical system (EMS) display elements.

12. The apparatus of claim 1, further comprising:
a display;
a processor that is configured to communicate with the display, the processor being configured to process image data; and
a memory device that is configured to communicate with the processor.

13. The apparatus of claim 12, further comprising:
a driver circuit configured to send at least one signal to the display; and wherein
the controller further configured to send at least a portion of the image data to the driver circuit.

14. The apparatus of claim 13, further comprising:
an image source module configured to send the image data to the processor, wherein the image source module comprises at least one of a receiver, transceiver, and transmitter.

15. The apparatus of claim 12, further comprising:
an input device configured to receive input data and to communicate the input data to the processor.

16. A method for displaying images, comprising:
selecting, for a set of pixels, a number of display elements per pixel to respond to a corresponding data voltage provided by a single data source;
activating at least one area modulation control switch to implement the selection of the number of display elements per pixel to respond to the corresponding data voltage;
responsive to activating the at least one area modulation control switch, providing a write-enabling voltage to write-enabling switches corresponding to the number of display elements selected to respond to the corresponding data voltage;
providing the corresponding data voltage to each of the selected display elements; and
activating a light source to generate an image.

17. The method of claim 16, wherein selecting a number of display elements per pixel to respond to a corresponding data voltage includes determining a weight of a subframe to be displayed.

18. The method of claim 16, wherein activating at least one area modulation control switch includes applying a control voltage to the at least one area modulation control switch via an area modulation control interconnect.

19. The method of claim 16, further comprising:
causing the selected display elements to achieve a first light-transmissive state upon providing a first data voltage; and
causing the selected display elements to achieve a light-blocking state upon providing a second data voltage.

20. An apparatus for displaying images, comprising:
a selection means for selecting, for a set of pixels, a number of display elements per pixel to respond to a corresponding data voltage provided by a single data source;
at least one area modulation control means for implementing the selection of the number of display elements per pixel to respond to the corresponding data voltage;
a write-enabling means for enabling the selected number of display elements pixels to respond to the corresponding data voltage;
means for providing the corresponding data voltage to each of the selected display elements; and
means for illuminating the set of pixels to generate an image.

21. The apparatus of claim 20, wherein selecting a number of display elements per pixel to respond to a corresponding data voltage includes determining a weight of a subframe to be displayed.

22. The apparatus of claim 20, further comprising:
an update means for causing the selected display elements to achieve a first light-transmissive state upon providing a first data voltage and for causing the selected display elements to achieve a light-blocking state upon providing second data voltage.

23. A processor-readable storage medium having computer-executable instructions stored thereon, which when executed by a processor, cause the processor to:
select a number of display elements per pixel to respond to a corresponding data voltage provided by a single data source;
activate at least one area modulation control switch to implement the selection of the number of display elements per pixel to respond to the corresponding data voltage;
provide a write-enabling voltage to write-enabling switches corresponding to the number of display elements selected to respond to the corresponding data voltage;
provide the corresponding data voltage to each of the selected display elements; and
activate a light source to generate an image.

24. The processor-readable storage medium of claim 23, wherein selecting a number of display elements per pixel to respond to a corresponding data voltage includes determining a weight of a subframe to be displayed.

25. The processor-readable storage medium of claim 23, wherein activating at least one area modulation control switch includes applying a control voltage to the at least one area modulation control switch via an area modulation control interconnect.

26. The processor-readable storage medium of claim 23, further comprising computer-executable instructions, which when executed by the processor, cause the processor to:
cause the selected display elements to achieve a first light-transmissive state upon providing a first data voltage; and
cause the selected display elements to achieve a light-blocking state upon providing a second data voltage.
